(19) United States
(12) Patent Application Publication
(10) Pub. No.: US 2018/0257181 A1
(43) Pub. Date: Sep. 13, 2018

(54) METHOD OF CLADDING AND FUSION WELDING OF SUPERALLOYS

(71) Applicant: Liburdu Engineering Limited, Dundas (CA)

(72) Inventors: Alexander B. GONCHAROV, Toronto (CA); Joseph Liburdi, Dundas (CA); Paul Lowden, Cambridge (CA); Scott Hastie, Toronto (CA)

(73) Assignee: Liburdu Engineering Limited, Dundas (CA)

(21) Appl. No.: 15/980,315

(22) Filed: May 15, 2018

Related U.S. Application Data
(63) Continuation-in-part of application No. 14/468,680, filed on Aug. 26, 2014, now abandoned.
Application No. 14/468,680 is a continuation of application No. PCT/CA2012/001118, filed on Dec. 5, 2012.

(30) Foreign Application Priority Data
Dec. 5, 2012 (CA) PCT/CA2012/001118

(51) Int. Cl. B23K 35/30; B23K 1/00; C21D 9/50; C22F 1/10; C22C 19/05

(52) U.S. Cl. CPC B23K 35/304; B23K 1/0018; F01D 5/005; C22F 1/10; C22C 19/051; C21D 9/50

(57) ABSTRACT

The present concept is a method of cladding and fusion welding of superalloys and includes the steps of firstly application of a composite filler powder that comprises 5-50% by weight brazing powder which includes melting point depressants, and 50-95% by weight high temperature welding powder, to a superalloy base material. Secondly there is simultaneous melting of the base material and the composite filler powder by a welding heat source that is movable relative to the base material. There is heating to a temperature that will fully melt the brazing and high temperature welding powder and also melt a surface layer of the base material, thereby forming a weld pool followed by heat treatment with a partial re-melt of interdendritic B based eutectics.

### CROSS-REFERENCE TO RELATED APPLICATIONS

This application is a continuation-in-part (CIP) of U.S. patent application Ser. No. 14/468,680, which is a continuation of prior international application No. PCT/CA2012/001118, filed Dec. 5, 2012, under the title, “METHOD OF CLADDING AND FUSION WELDING OF SUPERALLOYS,” having a first inventor Alexander B. Goncharov.

### FIELD OF THE INVENTION

The invention relates to fusion welding and filler materials for fusion welding and can be used for manufacturing and repair of turbine engine components made of nickel, cobalt and iron based superalloys utilizing gas tungsten arc welding (GTAW), laser beam (LBW), electron beam (EBW), plasma (PAW) and micro plasma (MPW) manual and automatic welding.

### BACKGROUND OF THE INVENTION

The present invention is related to fusion welding and can be used for joining, manufacturing and repair of articles, especially turbine engine components, manufactured of conventional polycrystalline, single crystal and directionally solidified superalloys utilizing fusion welding processes.

In fusion welding, coalescence or joining between two or more articles takes place by melting of a base material with or without introduction of a filler material, followed by cooling and crystallization of a welding pool. Fusion welding can produce properties equal to those of the base material in wide range of temperatures and conditions. However, accommodation of solidification and residual stresses often results in cracking of difficult to weld Inconel 713, Inconel 738, Rene 77, CMSX-4, CMSX-10, Rene N4, Rene 5, Rene 6, Rene 80, Rene 125, Rene 142, Mar M247, Mar M002 and other superalloys with low ductility.

Brazing can produce crack free joints because it does not require melting of a base material to obtain coalescence. Brazing is carried out by melting and solidification of only brazing materials. However, the mechanical properties of brazed joints are usually below the mechanical properties of the base material by 50-75% at high temperature, and can lead to a brittle joint or those having low ductility. For instance, Chesnes (U.S. Pat. No. 6,454,885) uses brazing and filler powders, and discloses heating the components to brazing temperatures that melts only the brazing powder without melting of the base material and filler powder. As a result, the brazed joints produced by the teaching of Chesnes will be fully un-brazed during heat treatment at temperatures exceeding brazing temperature (for instance, during welding) and lose structural integrity and geometry of the brazed joints.

The poor mechanical properties of brazed joints produced by most nickel and cobalt brazing materials do not allow extensive dimensional restoration of turbine blades and other engine components.

Therefore, despite the propensity for cracking, welding is used more often than brazing for manufacturing and repair of different articles including turbine engine components.

For example, repair of turbine blades as per WO 2009012747 is made by removing of a damaged portion of a blade followed by rebuilding of the removed portion by a weld build-up using LBW also known as cladding with a powder filler material.

The method disclosed in EU 102004002551 comprises removing of damaged material, laser powder deposition to the repair area and machining to obtain the required profile.

A similar method is described in U.S. Pat. No. 6,269,540. It comprises cladding using a laser beam that is moved relative to a repair surface and filler material that is supplied to the surface in such a way that the laser beam melts a thin layer of the metal substrate and filler material forming a fused metal on a surface of the blade. This process is repeated until a desired blade section is fully restored.

Low ductility turbine blades manufactured of nickel and cobalt based precipitation hardening and directionally solidified superalloys are highly susceptible to cracking during welding and heat treatment.

Therefore, to avoid cracking during fusion welding turbine blades manufactured of materials having a low ductility are preheated prior to welding to a temperature between 1800° F. (982° C.) to 2100° F. (1148° C.) as per U.S. Pat. No. 5,897,801. Welding is accomplished by striking an arc in the preselected area so as to locally melt the parent material providing a filler metal having the same composition as the nickel-based superalloy of the article, and feeding the filler metal into the arc that results in melting and fusion of the latter with the parent material forming a weld deposit upon solidification.

A similar approach of welding at a high temperature is utilized in the method disclosed in U.S. Pat. No. 6,659,332. The article is repaired by removing of damaged material, which is present in the defective area, followed by preheating of the article to a temperature of 60-98% of the solidus temperature of the base material in a chamber containing a protective gas.

In order to minimise welding stress in the blade due to the application of considerable thermal energy during fusion welding processes, blades are subjected to controlled heating prior to and controlling cooling after weld repair in accordance with the method described in CA 1207137.

Preheating of turbine blades increases the cost of a repair and does not guaranty crack free welds due to the low ductility of components produced using precipitation hardening superalloys.

The direct metal laser sintering process as per US 2010221567 comprises the steps of applying of a cladding material with a melting temperature that is below the melting temperature of the substrate at least to a portion of the article and heating the cladding material to a temperature that exceeds the liquidus temperature allowing wetting of the surface and formation of a solid compound during subsequent cooling and solidification. To prevent oxidation, this process is carried out in vacuum or protective atmosphere. This method was based on a high temperature brazing processes described in U.S. Pat. No. 6,454,885, U.S. Pat. No. 6,383,312, U.S. Pat. No. 6,454,885, U.S. Pat. No. 8,123,105 and other prior art and therefore, has similar short comings.

The major disadvantage of this method is a full re-melting of braze clad welds during post weld solution or rejuvenation heat treatment that changes the geometry of the weld beads limiting the size of repair areas to one single pass.

Additionally, as it was found by experiments in as welded condition welds produced using Ni and Co based brazing materials with high contents of melting point depressants such as B and Si are prone to extensive cracking and, therefore, are not suitable for use in the ‘as welded’ condition.

Previous attempts to produce crack free welds on Inconel 738 using standard filler materials were not successful in accordance with Banerjee K., Richards N. L., and Chaturvedi M. C. “Effect of Filler Alloys on Heat Affected Zone Cracking in Pre-weld Heat Treated IN-738 LC Gas-Tungsten-Arc Welds”, Metallurgical and Materials Transactions, Volume 36A, July 2005, pp. 1881-1890.

To verify results above within the scope of the current development the evaluation of the weldability of Inconel 738 using standard homogenous welding materials that include standard AMS 5786 (Hastelloy W) and AMS 5798 (Hastelloy X) nickel based welding wires which comprise numerous alloying elements including Si with a bulk content of 0.2-1 wt. %, Haynes HR-160 nickel based welding wire with bulk content of silicon of 2.75 wt. %., nickel based alloys with a content of Si from 0.05 wt. % to 2 wt. % similar to the material described in U.S. Pat. No. 2,515,185, and more complex nickel based superalloy that comprises up to 0.05 wt. % B and 2.0 wt. % Re as per U.S. Pat. No. 6,468,367 was conducted.

Regardless of the chemical composition all welds produced using standard welding materials at an ambient temperature exhibited extensive intergranular micro cracking in the HAZ (heat affected zone) along the fusion line between the base material and weld beads.

HAZ cracking in Inconel 738 was related to an incipient melting of low temperature eutectics, carbides and other precipitations along grain boundaries during welding followed by a propagation of cracks due to high level of residual tensile stresses into the HAZ. Lack of low temperature eutectics and rapid cooling did not allow full crack back filling during welding as was shown by Alexandrov B. T., Hope A. T., Sowards J. W., Lippold J. C., and McCracken S. S, in the publication titled: Weldability Studies of High-Cr, Ni-base Filler Metals for Power Generation Applications, Welding in the World, Vol. 55, n. 3/4, pp. 65-76, 2011 (Doc. IIW-2111, ex Doc. IX-2313-09).

The post weld heat treatment (PWHT) of these welds resulted in an additional strain-aging cracking in the HAZ. Some cracks propagated into the welds.

Therefore, currently only preheating to temperatures exceeding 900° C. allows crack free welding on Inconel 738, Inconel 713, GDT 111, GDT 222, Mar M247 and other precipitation hardening polycrystalline and directionally solidified high gamma-prime superalloys, as well as Mar M 247, CMSX 4, CMSX 10, Rene N5 and other single crystal materials.

However, preheating of turbine engine components prior to welding increases the cost and reduces the productivity of welding operations.

Therefore, one of major objectives of the present invention is the development of a new cost effective method for welding and cladding on polycrystalline, directionally solidified and single crystal superalloys at an ambient temperature that will allow self-healing of cracks during welding and post weld heat treatment.

Additionally it is another objective to develop parameters for a post weld heat treatment (PWHT) for the self-healing of cracks during a PWHT.

### BRIEF DESCRIPTION OF THE INVENTION

The method of cladding and fusion welding includes the steps of:

(a) application of a composite filler powder to a superalloy base material, the composite filler powder comprising 5-50% by weight brazing boron bearing powder and 50-95% by weight high temperature nickel based superalloy welding powder comprised at least one of Cr, Mo, W and Re alloying elements, wherein a bulk content of boron in a weld bead after solidification is within a range of 0.15-1.2% by weight;

b) simultaneous heating of the base material and the composite filler powder by a welding source that is movable relative to the base material with a speed from 2 to 45 inches per minute and a heat input from 200 W to 500 W that configured to fully melt the brazing powder and the high temperature welding powder and also a surface layer of the base material, which upon solidification forms a structure having an interconnected framework of high melting temperature columnar dendrites in an interconnected interdendritic boron bearing eutectic matrix, and

c) post weld heat treatment at a temperature exceeding a liquidus temperature of the brazing powder but below the solidus temperature of the high temperature welding powder, configured to at least partially re-melt the interconnected inter-dendritic eutectic based matrix self-filling a solidification cracks in the weld bead or a liquation crack along a weld fusion line wherein a weld geometry is supported by the interconnected framework of high melting temperature columnar dendrites.

The article repaired using the preferable embodiment comprises an originally manufactured defect free base material with a damaged area being removed prior to a repair and replaced with the composite weld material comprising of a continuous framework of a high temperature dendrites produced during solidification of a welding pool and a braze based matrix containing melting point depressants.

In accordance with other preferable embodiments the crack healing or thermal treatment is made by local heating of the weld bead using a welding source during welding.

As per preferable embodiment the post weld heat treatment of the article is done at a temperature above liquidus temperature of the brazing powder but below of the solidus temperature of the welding powered or above 500° C. but below the solidus temperature of the braze material if the healing of stress-strain crack during post weld heat treatment is not required.

Welding results in the accumulation of residual stresses that aggravate cracking. To reduce residual stresses the stress relief or annealing should be performed. Annealing and crack healing heat treatment reduces mechanical properties of a base material. Therefore, further embodiments of the current invention based on performance requirements of base materials and service conditions may include HIP, annealing, aging or combination of annealing followed by aging.

Aiming to reduce distortion, residual stresses and cracking in accordance with another embodiment the post weld heat treatment is made after application of 2-10 weld passes.

Welding as per the preferable embodiment is made either using premixed brazing and welding powders with the required ratio using one powder hopper or mixing these powders during heating with welding sources using two separate powder hoppers. The welding sources are selected among laser, electron beam, electric arc or plasma.

Due to improve weldability depending on chemical composition and condition of the base material, the article prior to welding is subjected to a stress relief, aging or annealing heat treatment.

In accordance with the preferable embodiment crack free welds are produced for example when the ratio of the welding pool length to the welding speed is 0.002-0.02.

Repair of an article by welding can be made at an ambient temperature without preheating of the base material or with the preheating of the article to a required temperature using similar welding powder with approximately the same chemical composition as the base material, or with a dissimilar welding powder with a different composition as the base material and brazing powders which include from 1 to 10 wt. % of Si or from 0. 3 to 4 wt. % of B or mixture of Si and B as a melting temperature depressants from 1.2 to 10 wt. % with a total content of B not more than 4 wt. %

In other preferable embodiments the composite welding materials includes high temperature welding powder and brazing powder is used to produce a buttering pass followed by welding using a high temperature welding powder to produce a weld build up with the required geometry.

The invented method can be used for joining of at least two articles, manufacturing, repair and dimensional restoration of structural components, casings, nozzle guide vanes, compressor and turbine blades manufactured of polycrystalline, directionally solidified, single crystal and composite materials.

The following advantages were observed.

This method has been found to produce crack free welds at ambient temperature on most polycrystalline, directionally solidified and single crystal superalloys with a high content of gamma-prime phase and carbon, reducing the cost, increasing productivity and improving the health and safety of the work conditions.

The method results in formation of a heterogeneous composite weld bead structure consisting of a continuous framework of a high temperature and high strength dendrites and a ductile matrix that produces joints and weld metals with mechanical properties exceeding properties of brazed and classical homogenous welds made using standard solution hardening filler materials.

The formation of the heterogeneous composite structure in welds produced using optimized welding parameters occurs despite the melting of brazing and welding powders and base material within the same welding pool.

Welds deposited by this method exhibit self-healing of cracks during a post weld heat treatment eliminating necessity of costly rework.

They also exhibit superior oxidation resistance that exceeds the oxidation resistance of base and high temperature welding materials.

Advantageously there is also a wide window of optimal welding parameters that simplify process control.

The present concept is a method of cladding and fusion welding of superalloys comprises the steps of:

a) application of a composite filler powder to a superalloy base material, the composite filler powder comprising 5-50% by weight brazing boron bearing powder and 50-95% by weight high temperature nickel based superalloy welding powder comprised at least one of Cr, Mo, W and Re alloying elements, wherein a bulk content of boron in a weld bead after solidification is within a range of 0.15-1.2% by weight;

b) simultaneous heating of the base material and the composite filler powder by a welding source that is movable relative to the base material with a speed from 2 to 45 inches per minute and a heat input from 200 W to 500 W that configured to fully melt the brazing powder and the high temperature welding powder and also a surface layer of the base material, which upon solidification forms a structure having an interconnected framework of high melting temperature columnar dendrites in an interconnected interdendritic boron bearing eutectic matrix, and

c) post weld heat treatment at a temperature exceeding a liquidus temperature of the brazing powder but below the solidus temperature of the high temperature welding powder, configured to at least partially re-melt the interconnected inter-dendritic eutectic based matrix self-filling a solidification cracks in the weld bead or a liquation crack along a weld fusion line wherein a weld geometry is supported by the interconnected framework of high melting temperature columnar dendrites.

Another preferable embodiment is executed using the brazing powder includes boron and silicon as melting point depressants, wherein the bulk content of boron in a weld bead after solidification is within a range of 0.15-0.9% by weight and silicon is within a range of 0.5-1.5% by weight aiming to improve oxidation resistance of welds.

To optimize the solidification rate and temperature gradient to ensure formation of a columnar dendrites the welding parameters are chosen by experiments such way that the ratio of the welding pool length in inches to the welding speed in inches per minute is 0.002-0.02 during welding.

### BRIEF DESCRIPTION DRAWINGS

FIG. 1 is the micrograph of cross (a) and longitudinal (b) sections of Mar M247—AWS A5.8 BNi-9 clad welds produced on Inconel 738 using micro plasma welding after heat treatment.

FIG. 2 is the typical macrostructure of three pass laser beam clad weld (LBW) made on Inconel 738 with Inconel 738—AWS A5.8 BNi-9 filler material, wherein (a)—longitudinal samples in as welded condition, (b)—longitudinal samples after heat treatment (b).

FIG. 3 depicts the microstructure of the crack healing in the HAZ prior to a heat treatment (a) and macro structure of the three passes clad weld after PWHT at 1200° C. (b).

FIG. 4 is the macrostructure of the clad weld metal produced on Inconel 738 using Inconel 738—AWS A5.8 BNi-9 filler powder in as welded condition (a) and after heat treatment (b).

FIG. 5 depicts the macrostructure of the laser clad weld (a) and HAZ (b) produced on Inconel 738 using Inconel 738-AMS4782 filler powder after heat treatment.

FIG. 6 is a microstructure of the multi pass clad weld build up using Mar M247—AWS A5.8 BNi-9 filler powder for a buttering pass and Rene 80 for the top pass, wherein (a)—fusion area between Mar M247—AWS BNi-9 and Rene 80 clad weld on the top, (b)—heat affect zone (HAZ) that depicts the eutectic area.

FIG. 7 depicts a multi pass weld build up produced using Inconel 738-AWS A5.8 BNi-9 filler material.

FIG. 8 is a repaired turbine blade with the micrograph depicting the defect free base material (1), repaired section of the blade produced by the multi pass clad welding (2) and eutectic layer (3) in the HAZ that bonds the repair sections (2) to the base material (1).

FIG. 9 depicts formation of WGB material depicting: a). M247 powder in the original condition; b). Formation of scale in the surface of M247 filler powder particles; c). Solid state sintering of M247 at 1200° C.; d). WGB material after infiltration and sintering in the liquid state for two hours.

FIG. 10 shows a typical sample produced by multi-pass laser beam cladding in the annealed and aged condition using 100:25 powder blend.

FIG. 11 shows a typical cracking of LBW welds produced using standard M247 powder: a). Weld metal cracking occurred in M247 substrate; b). Heat affected zone cracking of the IN738 substrate.

FIG. 12 shows defect free LBW weld produced using mixture B powder blend: a). Epitaxial grain growth from the base material through clad welds and demonstration of healing of solidification micro crack in HAZ of IN738 substrate; b). Dendritic structure of clad welds depicting formation of interconnected eutectic matrix.

FIG. 13 shows tensile properties of M247-DF3 materials produced by WGB and LBW: a). Yield strength; b). Ultimate tensile strength; c). Elongation. (AWM refers to ‘All Weld Metal’ samples; ABM refers to ‘All Braze Metal’ samples; BJ refers to ‘Braze Joint’ samples)

FIG. 14 shows typical EDS of WGB ‘A’ material in the heat treat condition depicting formation of bulky Cr—Mo—W borides.

FIG. 15 shows LBW weld produced using ‘A’ powder blend after post weld annealing at 1200° C. depicting: a). optical microscopy micrograph; b). SEM micrograph.

FIG. 16 shows EDS of LBW of ‘B’ welds depicting precipitation of Cr—Mo—W borides depleted with Ni as deposited.

FIG. 17 shows EDS of LBW ‘B’ welds after annealing and aging depicting dissolution of the continuous interdendritic Ni—B based eutectics and precipitation of Cr—Mo—W borides.

FIG. 18 shows a microstructure of Mar M247-DF3 materials after annealing at 1200° C. followed by aging at 1120° C. for 2 hours and 843° C. for 24 hours depicting: a). Precipitation of gamma prime phase and cuboidal borides in LBW produced using ‘B’ material; b). Typical structure of partially sintered WGB ‘A’ material; c). Precipitation of gamma prime phase in WGB ‘A’ material.

FIG. 19 shows restoration of abutment faces of LPT NGV by welding: a). Vane manufactured of Mar M247; b). Micrograph of repaired by welding area.

### DETAILED DESCRIPTION OF THE INVENTION

### Terms and Definitions

Composite filler powder (material)—the material to be added in making of welded joints or clad welds comprised mix of dissimilar high temperature welding and brazing powders with different chemical composition, solidification range and properties.

Welding powder—the welding material in a form of powder that is added in making of welded joints or clad welds.

High temperature welding powder—welding powder with a solidus temperature above 1200° C. and below the melting temperature of tungsten of 3422° C.

Brazing powder—brazing material in a form of powder to be added in making of brazed joints with a melting temperature above 400° C. but below of a melting temperature of a base material and high temperature welding powder.

Base material or metal—metal or alloy of the article or component to be welded.

Similar welding powder (material)—material with approximately the same chemical composition as the base material.

Dissimilar welding powder (material)—material with different form the base material chemical composition.

Welding is a materials joining process which produces coalescence of materials by heating them to suitable temperatures, with or without the application of pressure or by the application of pressure alone, and with or without the use of filler metal.

Fusion Welding is the process wherein the base metals (substrates) of joining articles are melted with or without filler material that due to cooling result in coalescence.

Cladding—the process of the application of a relatively thick layer (>0.5 mm (0.02 in.)) of welding material and/or composite welding powder for the purpose of improved wear and/or corrosion resistance or other properties and/or to restore the part to required dimensions with minimum penetration into the base material.

Multi pass cladding—cladding with two or more consecutive passes of welding material and/or composite welding powder.

Brazing (High Temperature Brazing of Superalloys) is a material joining process in which two or more articles are joined together by heating articles and brazing material to brazing temperature in a furnace in protective atmosphere, melting of brazing material and flowing a brazing material by capillary actions into the joint, which forms the brazing joint due to cooling without melting of base materials of articles. Therefore, brazing differs from welding in that:

Brazing of superalloys with boron and silicon bearing brazing materials is conducted in vacuum furnaces in vacuum or protective atmosphere with heating the components to brazing temperature while welding results only in localized heating of the joining area.

Brazing does not involve melting of the base material of articles, while during fusion welding filler and base materials are melted producing the welding pool.

During brazing, the filler metal flows into the gap between close-fitting articles by capillary action while during welding base materials of articles and welding (filler) materials are melted and fused together.

Brazed joints do not form interconnected framework of high temperature dendrites by epitaxial growth and B and Si based matrix. This composite-like structure, described herein can be formed in the welded joints. Therefore, the post weld heat treatment of welded joints (described herein) results in melting only interdendritic eutectics while the original weld geometry is supported by the rigid interconnected frame work of high temperature dendrites. Brazed joints would be fully undone (destroyed) during similar heat treatment.

Superalloys brazed joints have low ductility and properties as it was previously shown by R. Sparling et al, “Liburdi Powder Metallurgy, Applications for Manufacture and Repair of Gas Turbine Components”, Table 2 (incorporated herein by reference) and W. Miglietti et al, High Strength, Ductile Braze Repairs for Stationary Gas Turbine Components—Part I, Table 6 (Journal of Engineering for Gas Turbines and Power, August 2010, v. 132, 082102-1 to 12, incorporated herein by reference).

High temperature brazing of superalloys with boron and silicon bearing brazing materials cannot be used for multi-pass repair of articles and 3D Additive Manufacturing (3d AM) because it will result in re-melting of all brazed joints and materials while the developed method can be used for 3D AM because it is accompanied only by local partial re-melt of previous welds.

Nickel and cobalt based boron and silicon bearing brazing materials are brittle and cannot be used directly for welding due to their propensity to cracking.

Gas tungsten arc welding=GTAW

Laser beam welding=LBW

Electron beam welding=EBW

Plasma arc welding=PAW

Oxy fuel welding=OAW

Post weld heat treatment=PWHT

Molten weld pool—a liquid or semi liquid state of a weld pool prior to solidification as weld metal.

Weld bead—a weld deposit resulting from a solidification of a welding material and/or composite welding powder during weld and/or clad pass.

Similar welding material—a welding material that have the same chemical composition as a base material.

Dissimilar welding material—a welding material with a chemical composition different from a base material.

Heat-affected zone (HAZ)—that portion of the base metal which has not been melted, but whose mechanical properties or microstructure have been altered by the heat of welding, cladding, brazing, soldering, or cutting.

Homogeneous weld bead—a weld bead consisting of similar grains, dendrites and phases with similar chemical composition, solidification range and physical properties.

Heterogeneous weld bead—a weld bead consisting of grains, phases and precipitates with different chemical compositions, solidus—liquidus or solidification ranges and physical properties. In the context of the subject application, heterogeneous welding takes place when filler material composition (in the current application, the composite filler powder containing the brazing powder and the high temperature welding powder) is different from base material composition; and results in a heterogeneous weld bead.

Partial re-melt of a weld bead—heat the composite welding bead to a temperature that exceeds a solidification temperature of the brazing powder but below of a solidification temperature of the high temperature welding powder.

Eutectic matrix—alloy that is formed during a metallurgical interaction of the brazing powder and the high temperature welding powder at a temperature that is below of a solidus temperature of dendrites in the composite weld bead.

Composite weld bead—alloy produced by welding or cladding and comprised at least two constituent, which are dendrites and eutectics, with different solidification range and properties.

Melting point depressant—a chemical element or elements that reduce the melting temperature of metals and alloys sometimes resulting in the formation of eutectics and an increase in the solidus—liquidus range also know as solidification range.

Solidus temperature—the highest temperature at which a metal or alloy is completely solid.

Liquidus temperature—the lowest temperature at which all metal or alloy is liquid.

Solidus—liquidus range or temperature—the temperature region between the solidus and liquidus wherein the metal or alloy is in a partially solid and partially liquid condition.

Weld penetration—the minimum depth a weld extends from its face into a base material or joint, exclusive of reinforcement.

Discontinuity—an interruption of the typical structure of a weld bead (metal), such as lack of homogeneity in the mechanical, metallurgical, or physical characteristics of the material or weld bead.

Weld defect—a discontinuity or discontinuities which by nature or accumulated effect (for example, total crack length) render a part or product unable to meet minimum applicable acceptance standards or specifications.

Crack—a fracture-type discontinuity that is characterized by a sharp tip and high ratio of length to width, usually exceeding three (3).

Fissure—a small crack-like discontinuity with only slight separation (opening displacement) of the fracture surfaces. The prefixes macro—or micro—indicate relative size.

Heterogeneous welding pool—is a molten or semi molten weld pool wherein liquefied dissimilar brazing, welding and base materials coexist with a non-uniform distribution of chemical elements prior to solidification into a composite heterogeneous weld bead.

Composite heterogeneous weld bead—a weld deposit resulting from solidification of a heterogeneous welding pool that produces at least two metallurgicaly bonded constituents such as in this case an interconnected framework of dendrites and an interdendritic eutectic matrix each with significantly different chemical composition, solidification range and physical properties.

Aging temperature—is a temperature at which a precipitation of secondary phases during heat treatment of metals and alloys from the oversaturated solid solution occurs.

Buttering welding pass—a surface preparation using a cladding fusion welding process that deposits surfacing metal on a base material to provide a metallurgicaly compatible weld metal deposit for the subsequent completion of the weld.

Superalloy base materials—are metallic materials that are used for a manufacturing of turbine engine components and other articles that exhibit excellent mechanical strength and resistance to creep (tendency of solid materials to slowly move or deform under stress) at high temperatures, up to 0.9 melting temperature; good surface stability, oxidation and corrosion resistance. Superalloys typically have a matrix with an austenitic face-centered cubic crystal structure. Superalloys are used mostly for manufacturing of turbine engine components.

Composite Weld Structure—heterogeneous structure comprises metallically bonded high temperature interconnected dendrite framework and eutectic matrix, wherein metal bonding arises from increased spatial extension of the valence metal atoms that brought close together during melting and solidification of a welding pool.

Originally manufactured article—an article which has never been subject to a repair.

### DESCRIPTION

Turbine blades of aero and industrial engines are manufactured of superalloys, directionally solidified and single crystal materials with a low ductility to ensure high rupture properties. However, low ductility reduces weldability of these materials due to limited capabilities of welds to accommodate residual stresses by plastic deformation.

To perform successful welding on materials having low ductility it is essential to minimize solidification stresses by reducing the melting temperature of filler materials, minimizing the depth of a penetration, overheating of a base material and increasing the solidification range of weld beads. This allows accommodation of solidification and thermal stresses by plastic deformation within weld beads.

The invented method addresses the cracking problem by the creation of self-healing welds wherein cracks in the weld beads and in the HAZ adjacent to the fusion line are self-healed during welding and post weld heat treatment. Additionally crack self-healing also called back filling of cracks also occurs during multi pass welding due to heat inputs of subsequent passes.

Surprisingly we used superalloy braze filler powders mixed with high temperature filler powders to obtain a crack free as well as crack self-healing weldments. Surprisingly because braze materials are notorious for producing brittle repairs on super-alloy material and therefore cannot be used for example in highly stressed areas of turbine blades in need of repair. To the best of my knowledge we are the first to have ever successfully used brazing materials in a welding process. We may also be the first to have used brazing material successfully or unsuccessfully in a welding process which unfortunately is unknown since failures are usually not reported or patented.

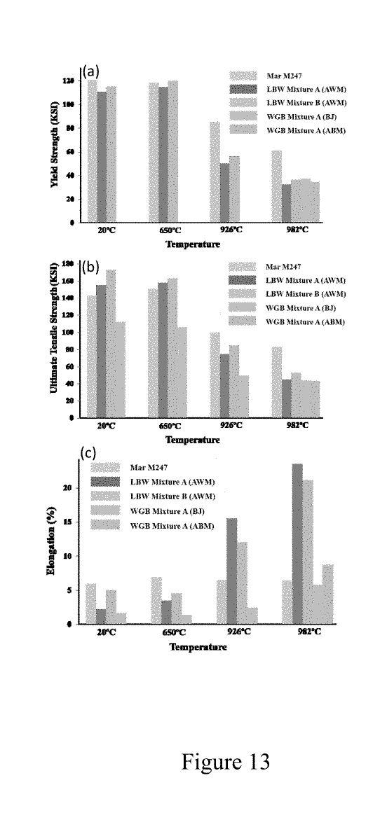

Elongation is one of the better measures of brittleness and the reader will note in FIG. 13 the low elongation values for WGB (ABM) (Wide Gap Brazing—All Braze Metal) compared to the presently invented process LBW A—AWM (Laser Beam Welding mixtures A—All Weld Metal). Please note that the chemistries namely Mixture A are identical in both cases. The Braze material exhibits elongations of the order of 2% (always the column on the far right in FIG. 13) over the normal operating temperatures of a turbine blade which is between: 650° C. and 926° C., whereas the present invention exhibits 4% to 12% which represents a doubling to a 6 fold improvement (the second column from the left in FIG. 13). This is remarkable since most (about 70%) of turbine blades fail in thermal cyclic fatigue cracking which is known to improve with decreased brittleness (ie increased elongation or ductility).

Furthermore the metallurgist is also aware that the mere presence of boron and silicon in superalloys is embrittling and also in many other alloys. These embrittlement's are well documented in the literature and also depicted in the results of FIG. 13. It is thought that the formation of nickel borides are responsible for the embrittling and that the presence of W, Mo, Cr, or Re preferentially form these borides therefore minimizing the formation of the nickel borides. The present concept however greatly negates the embrittling effect of the boron and silicon by producing a weld morphology which is an interconnected frame work of high melting temperature columnar dendrites in an inter-dendritic eutectic matrix which contains most of the boron and silicon. There were no published data to lead to this conclusion but we came across the concept during carefully planned welding experiments. We believe that high mechanical properties were obtained during the post weld heat treatment using optimized parameters that enhanced a formation of fine cuboidal borides of the Re and VIB group of periodic table elements thereby nullifying the traditional embrittling effect of boron in nickel by reducing the B content in Ni-based solid solution below of 0.03 wt % while the bulk boron content in welds was at much higher level of 0.15-1.2 wt. %.

Additionally we also believe the composite filler powder together with non-equilibrium cooling of the weld bead results in substantial segregation of the embrittling elements boron and silicon to the inter dendritic eutectic region where they depress the melting point allowing self-healing or back filling of any incipient cracks that may arise. This further increases ductility due to disappearance of micro cracks. Finally we believe the high melting temperature columnar dendrites are minimally infused with Boron and Silicon from the braze filler due to the non-equilibrium cooling of the welding process thereby the columnar dendrites are able maintain their superior base metal properties and not succumb to the embrittlement of the boron or silicon.

What follows is a discussion of the experimental results and a direct comparison with the brazing process using the same chemistries which contrast the results achieved against the results one would normally expect to obtain using braze materials.

The invented method is disclosed using by way of example only the repair of turbine blades manufactured of Inconel 738.

Prior to the weld repair, turbine blades as well as other turbine engine components such as nozzle guide vanes (NGV), compressor blades, turbine cases and other engine components are subjected to a stripping of the protective coatings if any and descaling and cleaning in accordance with relevant Original Equipment Manufacture (OEM) standard procedures.

After cleaning, turbine blades are subjected to fluoro penetrant inspection (FPI) as per AMS2647 or ASTM DE1417 or OEM standards followed by a dimensional inspection.

Prior to welding the turbine blades manufactured of precipitation hardening polycrystalline superalloys such as Inconel 738 may also be subjected to a rejuvenation heat treatment or High Isostatic Pressure (HIP) treatment to restore rupture and fatigue life of parts and improve ability of a base material to withstand a welding.

For example, rejuvenation (solution) annealing of Inconel 738 is carried out at a temperature of 1190° C.±10° C. for 2-4 hours followed by a controlling cooling to reduce amount of γ′-phase.

After heat treatment, the damaged material from the repair area is removed mechanically by machining or manual grinding using a hand held rotary file and tungsten carbide burrs.

Defective material must be completely removed to ensure sound welds. Therefore, after machining the repair area is subjected to FPI to verify complete crack removal followed by degreasing using alkaline, acetone, methanol or steam cleaning.

The premixed composite welding powders may include 5-50% boron based brazing powders such as AWS A5.8 BNi-9 (further AWS BNi-9), AMS 4777 or silicon based braze AMS 4782 or silicon-boron based brazing powder Amdry 788, and a high temperature welding powder. The high temperature welding powder can have similar chemical composition as a base material or different from the base material chemical composition to produce more superior welds.

Composite welding powders comprised the high temperature welding powder Inconel 738, or dissimilar powders having superior oxidation resistance such as Mar M247, Rene 80, Rene 142 or custom made powders with brazing powders are prepared in advance or produced directly in the standard multi hoper powder feeder during cladding.

Selection of brazing and high temperature welding powders is based on service temperature, the stress—strain condition of the repair area and chemical composition of a base material.

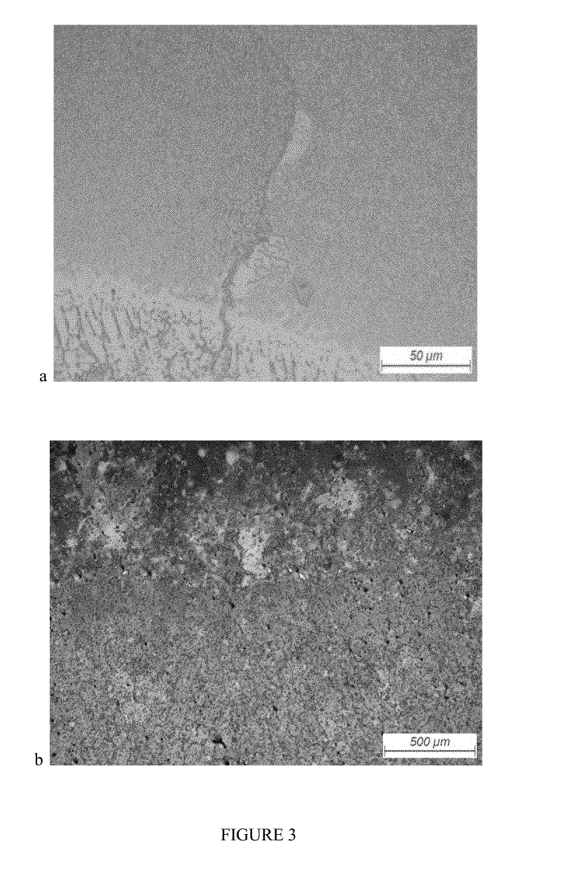

For example, for a repair of low pressure turbine blades that are exposed to moderate temperatures boron based brazing powders are the best choice. This is due to the ability of boron to diffuse easily into HAZ producing eutectics that heal micro cracks adjacent to the fusion zone by the formation of eutectics having lower than parent material melting temperatures. These eutectics metallurgically bond welds to the parent material creating unique structure shown in FIG. 3, b.

For relatively light turbine blades of aero engines that are exposed to hot and harsh conditions silicon based brazing powders such as AMS 4782 and others are more preferable because they have better oxidation resistance than boron based brazing materials.

High pressure turbines blades of heavy industrial engines that are exposed to high temperature and stresses might be repaired using silicon-boron based AWS BNi-10, BCo-1 or similar brazing powders.

The same approach could be used for selecting high temperature welding powders that can be produced of similar or dissimilar iron base, nickel base, cobalt base superalloys.

During cladding high temperature welding and brazing powders as well as the base material could be melted by numerous heat or welding sources such as laser or electron beam, arc and plasma.

Laser and micro plasma welding are currently the most advanced processes for the tip restoration of turbine blades. Therefore, these welding processes are discussed in more details. The heat input during welding is minimized while welding speed is maximized for reducing the depth of penetration, dilution, size of the welding pool, and solidification time.

The solidification and cooling of the welding pool produced using optimized welding parameters results in the formation of composite heterogeneous weld beads comprised of a continuous interconnected framework of dendrites produced by the high temperature welding powder and interdendritic eutectics formed by the brazing and welding powders and base material.

By experiment it was found that optimal conditions for the formation of composite heterogeneous weld beads were achieved in laser cladding with a ratio of length of the welding pool in inches to welding speed in inches per minute from 0.002 to 0.02.

Melting of the substrate by laser beam with introduction into the weld pool the composite welding powder resulted in a fusion of all materials and formation of a metal bonding between clad welds and base material. The chemical composition of the first layer depends on the dilution and depth of penetration.

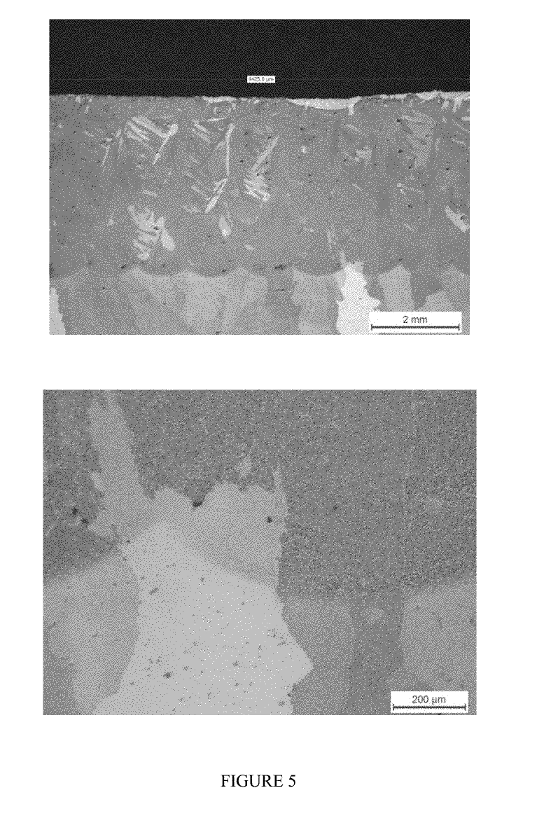

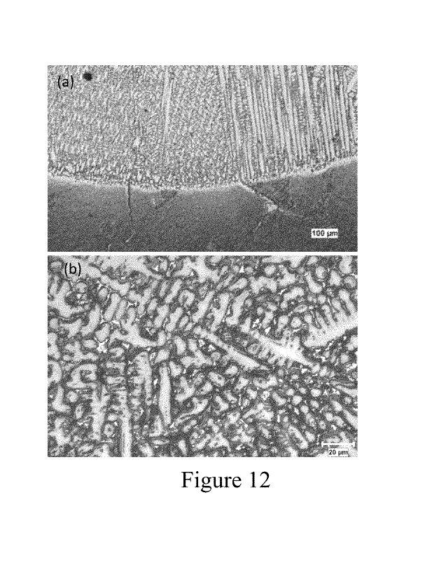

A columnar dendritic structure with epitaxial grown of dendrites perpendicular to the substrate is formed along the fusion zone during solidification of the welding pool. With solidification progress the growth direction of dendrites tilted into the weld direction resulting in the formation of equiaxed or prolonged grains oriented parallel to the substrate at the top section of clad welds. However, in multi pass cladding the top sections of welds were re-melted which resulted in the formation of the interconnected framework of dendrites throughout the entire clad welds starting from the base material as shown FIGS. 5 and 12. One way of ensuring that the correct welding parameters were used is that the microstructure shown in FIGS. 5 and 12 namely columnar dendrites confirmed that optimal welding parameters were used.

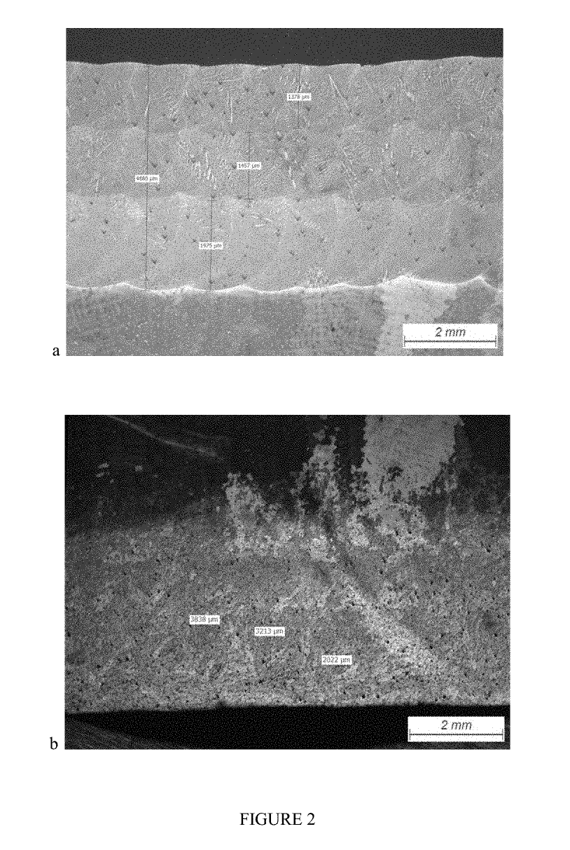

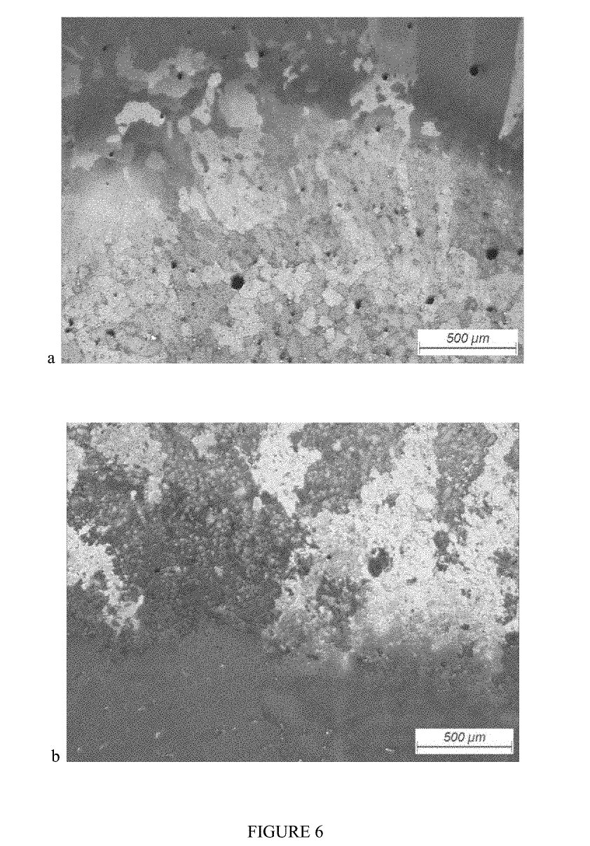

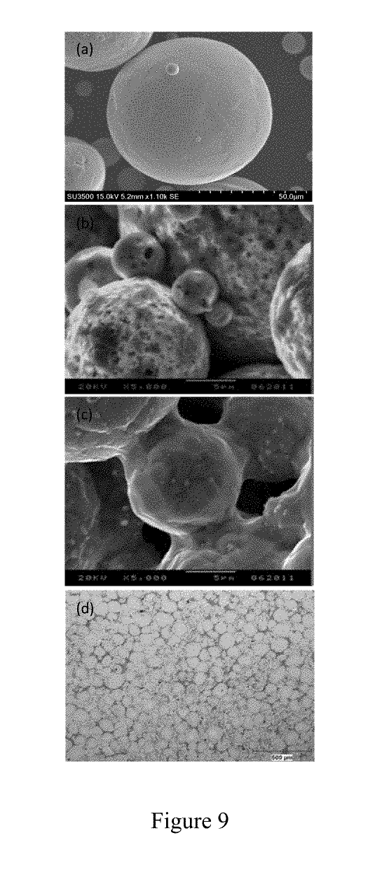

The formation of columnar dendritic structures in welds is described by John N. Dupont in the paper titled: Fundamentals of Weld Solidification ASM Handbook, Volume 6A, Welding Fundamentals and Processes, pages 96-114, 2011 (incorporated herein by reference). In particular, starting on page 101 subtitled Application to Fusion Welds, the author goes into detail to discuss and model the development of the various microstructural morphologies that are exhibited in fusion welds including columnar dendritic structures and quantifies the transition between the various microstructures that are observed in fusion welds. In addition, the publication entitled: Welding Handbook, 7th Edition, Volume 1 Titled: Fundamentals of Welding, published by the American Welding Society, page 88, 1980 (incorporated herein by reference), the author notes that most alloys of technical importance freeze dendritically. On the same page 88, the author quantifies the solidification times of fusion welds and discusses the effect of solidification time on dendrites spacing and dendrite structure. Further, the book entitled: Welding Metallurgy by Sindo Kou, Second Edition, published by A. John Wiley and Sons Incorporation in 2002 (incorporated herein by reference), on pages 161-169 as well as pages 199-205 of that publication, which provides further information on columnar dendritic structures. In particular, on pages 161-169 of the publication, there is discussion in detail on the formation of dendritic structures in fusion welding and on (FIG. 6.20 of page 160) provides a pictorial summary of the various microstructures that are obtained in fusion welding including columnar dendritic microstructures. Furthermore, chapter 8 entitled Weld Metal Solidification 2: Microstructure with Grains models and quantifies the growth of the dendritic structure in the weld pool, which on page 201, provides equation 8.3 (R=V cos α, where V is the welding speed, R is the dendrite growth rate, and a is the angle between welding direction and the solidification front). The author of this chapter goes into great detail to quantify and mathematically model the solidification parameters required to produce columnar dendritic microstructures. In chapter 1 titled: Weld Solidification in the publication entitled Weld Integrity and Performance, published by ASM International (incorporated herein by reference) there is discussion on the various dendritic structures that occur in fusion welding (in particular, FIG. 2 as well as FIG. 9).

In one aspect, the specification discloses that the chemical composition of weld beads produced at the heating step of the base material and the composite filler powder with welding parameters can lead to an interconnected framework of high melting temperature columnar dendrites in a continuous interdendritic boron or/and silicon bearing eutectic matrix.

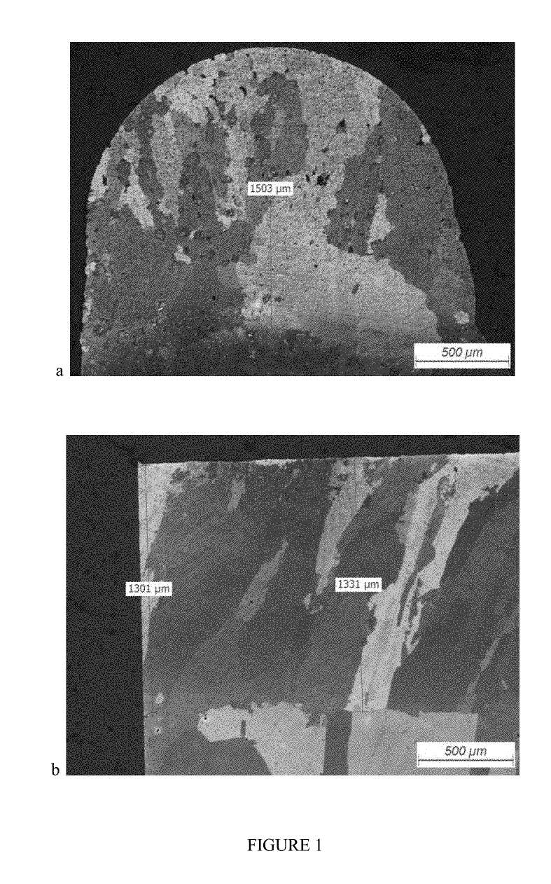

During solidification planar, cellular, columnar dendrite, and equiaxed dendrite structure can be formed. To attain high stability of weld geometry and provision of post weld heat treatment of welds at temperatures exceeding brazing temperature, columnar dendritic structure should be formed by the epitaxial growth from the base material as shown in FIGS. 1, 3a, 5.

The type (morphology) of welds can depend on the solidification velocity and temperature gradient which is related to welding parameters. During a solidification of a welding pool in multilayer clad welds, the base material can act as a heat sink and solidification is usually directional. Therefore, along the weld-base metal, interface structure may vary from planar at low growth rates to cells and to dendrites which become finer and finer until they will again generate formation of the cellular structure (M. Gaumann et al “Epitaxial laser metal forming: analysis of microstructure formation”, Materials Science and Engineering A271 (1999) pp. 232-241 (incorporated herein by reference).

Type of the structure formed in welds can depend on the temperature gradient G and solidification velocity V. Solidification velocity (V) can be calculated based on the welding speed using well-known equation V=V_{β}·cos ϑ, where in V_{β} is a welding speed and ϑ is the angle between grown direction and direction of welding. Temperature gradient can depend of welding parameters and technology.

Therefore required solidification velocity to form columnar dendritic structure can be selected based on the welding speed and welding parameters either by experiment for each giving chemical composition similar to Gaumann, or calculated using known Rosenthal equations or numerically as it was described by Promoppatum et al “A Comprehensive Comparison of the Analytical and Numerical Predication of Thermal History and Solidification Microstructure of Inconel 718 Products Made by Laser Powder-Bed Fusion”, Engineering 3 (2017) pp 685-694 (incorporated herein by reference).

However, calculation of solidification velocity and temperature gradient can be done only for exact chemical composition, which might be time consuming for all variabilities of alloys. Therefore, it might be more efficient to select welding parameters that results in a formation of the required structure by experiments of welding samples using for guidance welding parameters, and that can provide optimal ration of ratio of the length of the welding pool to the welding speed from 0.002 to 0.02, that were found by experiment, and performing standard metallographic examination of welds.

In a further aspect, formation of interconnected framework of high temperature dendrites in the continuous B and Si based matrix can be achieved by nickel based superalloy welds having a bulk content of boron from 0.2 to 0.9 wt. % and/or silicon within a range from 0.5 to 1.5 wt. %, in combination with the welding parameters disclosed herein.

In another further aspect, high welding speed and solidification rate, low heat input, small length of weld pool and limited stirring of a liquid metal created non-equilibrium conditions for solidification. This results in the formation of composite heterogeneous weld beads wherein the boron and silicon rich eutectics segregated along dendrites and grain boundaries creating a matrix having superior ability to self heal cracks.

Healing of micro cracks in the HAZ with the liquid braze based matrix was also observed during welding. However, due to rapid solidification and cooling of the welding pool large cracks adjacent to the fusion line were not fully healed.

To fully heal all weld and HAZ cracks turbine blades were subjected to a post weld heat treatment (PWHT) at a temperature that exceeded a solidification temperature of a brazing powder but was below of the solidification temperature of high temperature welding powder resulting in partial re-melting of only the braze base matrix while the geometry of composite clad welds was supported by the continues framework of high temperature dendrites.

In accordance with another preferable embodiment the first stage of the PWHT is made within the solidus—liquidus range of welds that can be determined by the thermal diffusion analysis (DTA) of welds in advance or by series of experiments.

To prevent formation of voids during the PWHT, the braze based matrix has to be interconnected throughout the entire weld. Therefore, a selection of appropriate welding and brazing powders and optimization of welding parameters played a critical role in the self healing of cracks.

It was found that the invented process can be used to heal cracks up to 0.8 mm in width and up to 20 mm in length which has not being observed in any of prior arts.

Extended soaking time allowed diffusion of boron and to some extent silicon into the base material. Diffusion of boron was also observed into the dendrites produced by the high temperature welding powder resulting in a formation of eutectics in the HAZ of Inconel 738 that was accompanied by crack healing. We observed the elimination of all evidences of original cracking to a depth up to 1.8 mm as shown in FIG. 3, b.

Various weld repairs of turbine blades of industrial and aero turbine engine components as well as nozzle guide vanes (NGV) have been made using dissimilar welding materials. Therefore, the major purpose of the PWHT is to restore the original mechanical properties of the base material and perform stress relief maximizing mechanical properties of welds.

To complete the self healing of cracks after welding, Inconel 738 alloys were heat treated at a temperature of 1120-1220° C. for two hours followed by an argon quench from a temperature of 980° C. This resulted in annealing of the base material, dissolution of gamma-prime and re-precipitation of carbides.

To restore the original mechanical properties of Inconel 738 base material a two stage PWHT at a temperature of 1120° C. for four (4) hours followed by aging at a temperature of 845° C. for sixteen (16) hours and argon quench was made.

It was observed that the typical microstructure of IN 738 after two stage aging comprised the cuboidal precipitation of gamma-prime in the austenitic matrix. Precipitation hardening with gamma-prime and carbides ensured high ultimate and yield strength of 49.4 KSI and 36.8 KSI respectively with an elongation of 15.5% and creep strength with a rupture time of 23.7 hours at stresses of 22 KSI and temperature of 982° C. Most grain boundaries after this heat treatment have had a serrated morphology contributing to extended blades rupture life.

Weld produced using the invented composite welding powders comprised an interconnected framework of high melting temperature dendrites and interdendritic nickel and cobalt based eutectic matrix enriched with boron (B—series), silicon (S—series) and boron and silicon (SB—series) that were subjected to a partial aging during the PWHT as well.

As a result, welds made with boron based brazing powder exhibited coarser grain boundary features and very fine cuboidal and spherical gamma-prime microstructure that was also typical for Inconel 738 in the aged condition.

Welds with silicon additives had much higher thermal stability. No evidences of recrystallization of primary austenitic grains and changing in morphology of dendrites were found. After two stage aging weld beads produced using Si based brazing powders had extremely fine cuboidal gamma-prime phase.

Welds with moderate amount of boron and silicon had transition microstructure. No evidences of cracking neither in the welds nor in the HAZ were found.

All three described types of brazing powders could be potentially used for welding on Inconel 738 turbine blades but welds produced using Si had the highest oxidation resistance as shown in Table 2, Example 9. Therefore, Si based brazing powders are most effective for a tip restoration of turbine blades while boron based brazing powders should be used for a weld repair of cracks in the blade platform.

After PWHT the repair area is subjected to machining or polishing for restoration of the original contour of the turbine blades.

Final FPI and/or radiographic inspection (X-ray) are made in accordance with relevant standards and specifications.

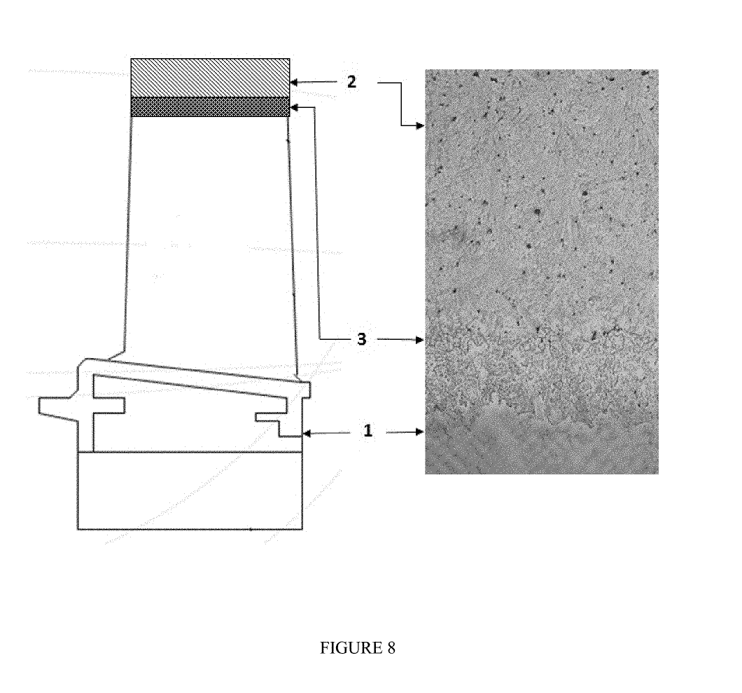

Typical drawing of the turbine blade that was repaired using the invented method and composite filler powder is shown in FIG. 8.

This blade comprised the original defect free section of the base material (1), in this case Inconel 738, and the repaired section (2) that was produced by a multi pass laser cladding and PWHT.

As a result, the repaired section of the blade includes an interconnected dendritic framework produced by the high temperature welding powder and braze based matrix that produced coalescence with the base material through the crack free eutectic layer (3) in the HAZ.

### Example A

The preferable embodiment of the developed method is aimed to substitute Wide Gap Brazing (WGB) process for a structure repair of turbine engine components and tip repair of HPT blades within Laser Beam Welding (LBW). Therefore, the microstructure and mechanical properties of materials produced by WGB and LBW cladding with different blends of Mar M247 and Amdry DF-3 brazing powders were studied in more detail. It was shown that LBW Mar M247 based materials comprised of 0.6 to 1 wt. % B were weldable. The weld properties were superior to WGB deposits with the same bulk chemical composition, due to the formation of an interconnected framework of high temperature dendrites in the interconnected continues braze based matrix, and the precipitation of cuboidal borides of Cr, Mo, and W and Re in the ductile Ni—Cr based matrix. Details of the study are described further below.

Mar M247 (M247) and Amdry DF-3 (DF3) filler and brazing powders shown in FIG. 9a were used for manufacture of test samples by WGB and LBW processes. Chemical compositions of the M247 and DF3 powders are provided in Table A.

TABLE A
Chemical composition of filler and brazing powders in wt. %
with Ni to balance

| | Alloy | | | | | | | | |
|---|---|---|---|---|---|---|---|---|---|
| | Cr | Co | Ta | B | W | Al | Hf | Ti | Mo |
| M247 | 8.25 | 10 | 3 | 0.015 | 10 | 5.5 | 1.5 | 1.0 | 0.7 |
| DF3 | 20 | 20 | 3 | 3-3.5 | — | — | — | — | — |

WGB joints of 6.35 mm in width and 7 mm in depth were produced using the LPM™ process on IN738 and M247 plates with a U-groove configuration to allow testing of transverse braze joints and longitudinal samples machined from the WGB material only. Prior to WGB, IN738 and M247 samples were subjected to vacuum cleaning at a temperature of ≥1200° C. for 2 hours in vacuum of ≤5·10⁻⁵ torr or better. A mixture comprised of M247 filler powder and oxygen bearing acrylic-based binder was carefully applied in the U-groove to avoid the formation of air pockets and voids. A similar DF3 brazing paste mixture was applied to the top of the filler powder putty. The ratio of M247 to DF3 was 100:40 by weight (Mixture ‘A’). The samples were then subjected to a multi-step heat treatment that included:

(a) Heating in vacuum to 1050° C. to decompose the binder and enhance the formation of thin oxide films at the surface of filler powder particles as shown in FIG. 9b;

(b) Solid state sintering of the M247 filler powder within the temperature range of 1050° C.-1200° C. for one (1) hour, producing metallurgical bonding between the powder particles as shown in FIG. 9c;

(c) Further heating to a temperature of 1205° C. stabilizing pressure of residual gasses at ≤1·10⁻⁵ torr aiming to remove surface oxidation and allowing braze infiltration through the solid state sintered M247 filler powder;

(d) Liquid state sintering for 2 hours to re-distribute the boron between the braze base matrix, M247 filler powder and base materials;

(e) Cooling below 900° C. in vacuum to consolidate the WGB material and form a braze joint followed by cooling in argon (argon quench) to produce a sound brazed joint between the M247 filler powder particles and substrate as shown in FIG. 9d.

After WGB, the brazed joints were subjected to a primary aging at 1120° C. for 2 hours followed by the secondary aging at 843° C. for 24 hours.

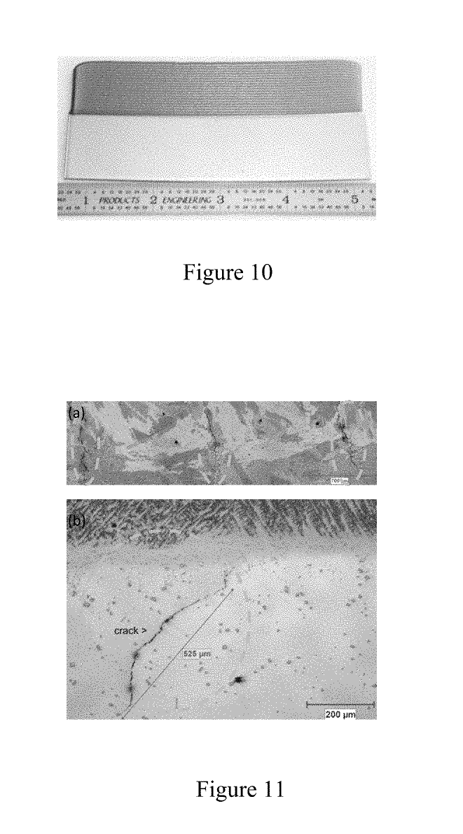

Composite M247 and M247/DF3 powder blends with ratios of 100:40 (Mixture ‘A’) and 100:25 (Mixture ‘B’) were used for LBW. The use of mixture ‘A’ was intended to allow direct comparison to the WGB samples. Multi pass welding was done on a sacrificial Haynes 230 substrate for the evaluation of mechanical properties of ‘All Weld Metal’ (AWM) samples. For the evaluation of the mechanical properties of dissimilar joints, multi-pass LBW cladding was made on IN738 and M247 substrates of 50 (1.96 in) and 100 mm (3.94″) in length, to produce weld buildup of 25 and 8 mm in height respectively, and ≈2 mm (0.78 in) (thin) and ≈7 mm (0.275 in) (thick) in thickness. LBW was performed at ambient temperature using the Liburdi LAWS 1000 welding system equipped with 1 kW IPG fiber laser. During cladding of the ‘thick’ samples, the laser head was oscillated with the amplitude of ±(3-3.5) mm (0.118″-0.138″) at a speed of about 18 mm/sec (47 inches/min) and a welding speed of about 0.7 (1.8 inches/min) mm/sec. The laser beam power was varied from 420 to 475 W and the powder feed rate varied from 3.5 to 4 g/min. Welding of ‘thin’ samples was performed with the oscillation of ±0.5 mm (0.02 in), welding speed of about 2.1 mm/s (5.5 inches/min), beam power of 200-500 W and powder feed rate of 6.5 g/min. A typical ‘thin’ LBW sample with sound weld is shown in FIG. 10.

After welding, test samples were subjected to an annealing heat treatment in vacuum at 1200° C. for two hours followed by the primary aging at 1120° C. for two hours and the secondary aging at 843° C. for 24 hours as per American Material Specification AMS 5410 for Class C IN738 superalloy. This heat treatment was selected for the repair of turbine engine components manufactured of IN738.

Round and flat sub-sized samples were manufactured from weld metal (AWM) and dissimilar joints (WJ) as per ASTM E-8. Tensile testing of samples at room temperature was conducted as per ASTM E-8 and at high temperature as per ASTM E-21. After machining all samples were subjected to a radiographic inspection per ASTM E-1032. Samples with discontinuities exceeding 0.1 mm in size were discarded. The obtained mechanical properties were compared to equiaxed M247 superalloy in the aged condition (Kaufman, M. “Properties of Cast Mar M-247 for Turbine Blisk Applications”. Proceeding of the Fifth International Symposium on Superalloys sponsored by the High Temperature Alloys Committee of The Metallurgical Society of AIME, held Oct. 7-11, 1984, Seven Springs Mountain Resort, Champion, Pa., USA. Superalloys. 1984. pp. 43-52., incorporated herein by reference).

Transverse and longitudinal samples for metallographic examination were extracted from randomly selected areas. After polishing, the samples for light optical microscopy were etched using standard Marble's etchant Samples for scanning electron microscopy (SEM) were electrolytically etched in 12 mL H₃PO₄+40 mL HNO₃+48 mL H₂SO₄ at 6V for 5 seconds.

Differential Thermal Analysis (DTA) was used to measure the solidus temperature and phase transformation during cooling. The heating and cooling rate was 10° C. per minute within the temperature range of 900↔1425° C. The mass of the samples was 0.2 g. Some samples were reheated twice to evaluate the effect of the initial condition and homogeneity of the material on phase transformation during cooling.

An SU-3500 Scanning Electron Microscope (SEM) with Energy Dispersive Spectroscopy (EDS) and a JEOL 8900 Electron-Probe Microanalysis (EPMA) were used to study the distribution of the alloying elements and boron in the welds in the ‘as welded’ and heat treat conditions. An interaction volume of around 15 μm³ for the EDS analysis was calculated from Monte Carlo simulation. The spatial resolution for EPMA was around 3 μm.

Metallographic examination showed that LBW welds produced using pure M247 powder were prone to interdendritic cracking as shown in FIG. 11a. Also, intergranular liquation cracks were found along the fusion line in the heat-affected zone (HAZ) of both IN738 and M247 substrates, as shown in FIG. 11b. The quantity of cracks in the HAZ and welds were progressively reduced with increasing the boron content. No cracks were observed in the HAZ of welds produced using mixture A and mixture B powder blends, as shown in FIG. 12.

The results of tensile testing are presented in FIG. 13. At lower temperatures, the tensile strength of the LBW samples was similar to or marginally greater than cast M247, while the ductility was significantly lower for mixture A. At higher temperatures, the LBW samples had significantly lower yield and ultimate tensile strength with respect to cast M247 and markedly higher ductility, particularly at 982° C.

By contrast, the WGB specimens exhibited significantly lower tensile strength than cast M247 throughout the testing range. The measured elongation of the WGB joint specimens was also significantly lower than the cast or welded material, except at the highest test temperature of 982° C. Fracture of all WGB butt joints took place through either the WGB or along the interface with the base material. At 982° C., the ductility of the WGB joint specimen was comparable to the cast material and the WGB all braze samples were significantly more ductile than cast M247. However, at all temperatures, the LBW samples had significantly higher ductility than WGB specimens, even for at 982° C. where all braze specimens were tested.

Solidification of the WGB materials is significantly different from the solidification of the LBW welds. The WGB process involves a two stage process that includes sintering in solid and liquid states, combined into one heat treatment cycle (U.S. Pat. No. 5,156,321 and Sparling, R. and Liburdi, J. “Liburdi Powder Metallurgy, Applications for Manufacture and Repair of Gas Turbine Components”, INSTITUTE OF MATERIALS; 987-1005 International Charles Parsons Turbine Conference; Parsons 2003, 6th, International Charles Parsons Turbine Conference; Parsons 2003, pp. 987-1005, incorporated herein by reference). The sintering and braze flow behavior was studied through examination of samples sintered without the braze constituent and by observation of the flow behavior.

During the first stage, which takes place in the temperature range 1050° C. to 1180° C., M247 filler powder particles undergo solid state sintering (diffusion bonding). Oxide films that were formed on the surface of powder (FIG. 9b) at these lower temperatures were found by EDS to contain mostly aluminum and chromium. These oxides prevent infiltration of the molten brazing material, which starts melting at 1052° C., but allow powder particle sintering, as shown in FIG. 9c, and powder particle to substrate bonding.

The sinter strength was found to be function of temperature. Sintering at a temperature of 1050° C. resulted in very light bonding of the powder particles, sufficient only to provide some structural integrity to powder particle skeleton during heat treatment in tilted and vertical positions. This is different from conventional WGB process which employ premixed filler and brazing powders that flow sluggishly when braze melting occurs.

At temperatures above 1180° C., the powder particles were well-bonded producing machinable porous materials.

Despite the low solidus—liquidus range of DF3, the braze infiltration process of M247 pre-sintered in the solid state starts only after dissociation of the surface oxides, particularly aluminum oxides, occurs. This allows wetting of M247 by liquid DF3 at temperatures ≥1200° C. Until this oxide is disrupted, the melted Amdry DF-3 brazing material remained at the surface of the pre-sintered M247 filler powder because wetting did not occur. When the oxide layer breaks down, brazing occurred from capillary actions and liquid was distributed throughout the porous structure.

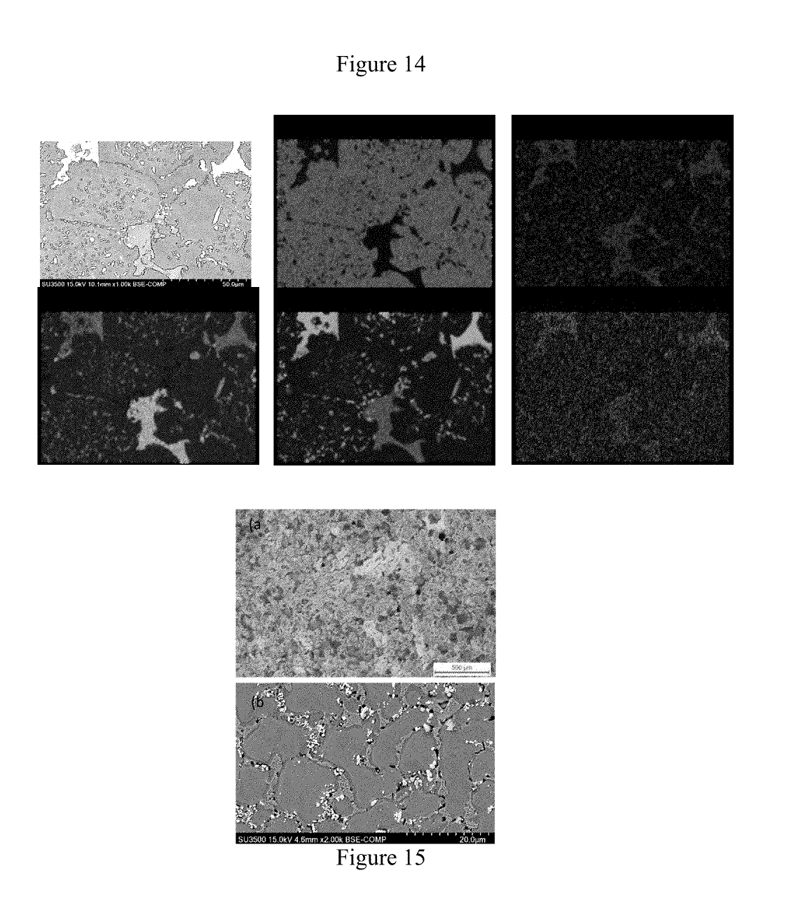

In the next stage of the process, liquid phase sintering at temperatures of ≥1205° C. for 2 and 10 hours result in boron diffusion into the base material and the filler powder particles and their partial dissolution into the liquid brazing material. Despite a relatively long sintering soak in the liquid state, the presence of eutectics in the solidified material indicates that isothermal solidification did not take place. Thus solidification of WGB materials starts from a partially melted state with relatively discrete powder particles surrounded by liquid braze at 1205° C. The result is a ‘composite-like’ structure containing braze-based eutectic surrounding M247 filler powder particles occurs (FIG. 9d). The boride spacing is determined by the particles size of about 50 μm. Increasing the sintering time from 2 to 10 hours reduced the amount of primary borides between the powder particles from about 16% to about 9%, while fine borides have precipitated within the powder particles. FIG. 14 shows the distribution of elements in the WGB material after completion of the liquid phase sintering step, indicating that both the eutectic borides formed during solidification and the precipitated borides in the powder particles are Cr, W and Mo rich.

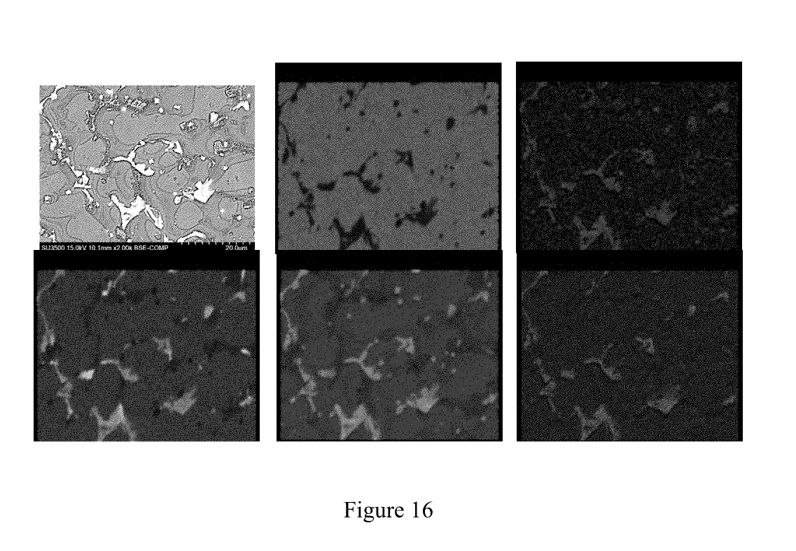

By contrast, cooling and solidification of the welding pool in LBW with mixture ‘A’ starts with the formation of dendrites around 1310° C., based on DTA measurements of welded specimens. As a result, an interconnected framework of high temperature dendrites with spacing on the order of 10 μm (FIG. 15b) is formed. Dendrite spacing is a function of temperature gradient and solidification rate during welding. Metallographic examination after welding shows a structure consisting of an interconnected framework of high temperature dendrites, interdendritic and intergranular boride eutectics as shown in FIG. 12b. Dendrite spacing is approximately 10-15 μm in both mixtures ‘A’ and ‘B’. The volume and thickness of the intergranular eutectics increased with boron content, as is evident by comparison of FIGS. 12b and 12b. FIG. 16 shows the elemental distribution in the as-deposited condition Similar to the WGB samples, the eutectic borides were found to be Cr W and Mo rich. No fusion zone or HAZ cracking was observed in welds produced either of the ‘A’ or ‘B’ powder blends.

Microhardness of the ‘B’ weld deposits in the as-welded condition increased from 520 HV adjacent to the substrate to 550 HV in the outer portions of the weld deposits. The softening may be due to reduced supersaturation of interstitial boron resulting from formation of boride precipitates of Cr, Mo and W. Subsequent welding passes heat the previously deposited layers into the range where solid state precipitation will occur. In ‘A’ weld samples, the micro hardness was about 540 HV throughout the whole weldment, probably due to higher boron content than in the ‘B’ weld deposits.

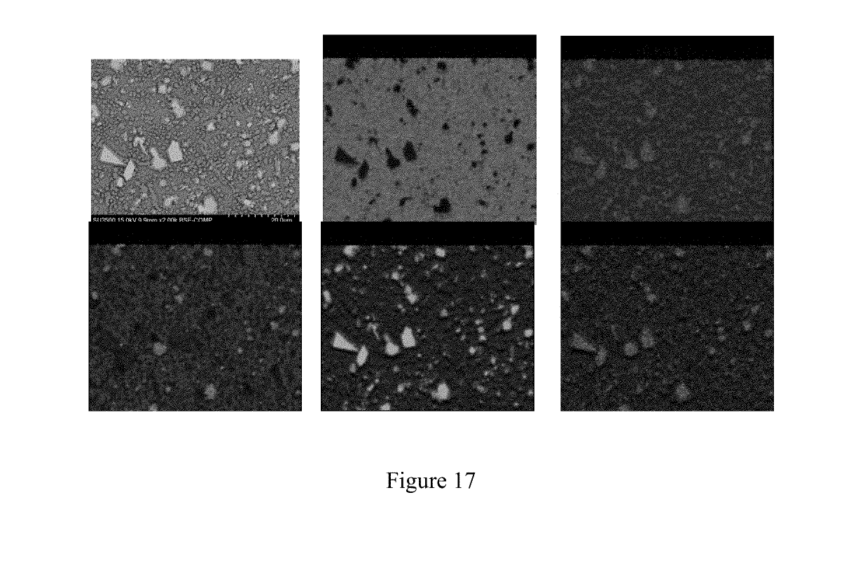

PWHT annealing of LBW welds at 1200° C. results in the partial re-melting of the low temperature interdendritic eutectics. Annealing of the LBW welds also redistributes boron between the boron rich eutectics and boron lean dendrites and substrate materials. As a result, development of fine cuboidal borides of VIB Group elements and dissolution of the coarse eutectics occurred, as shown in FIG. 17.

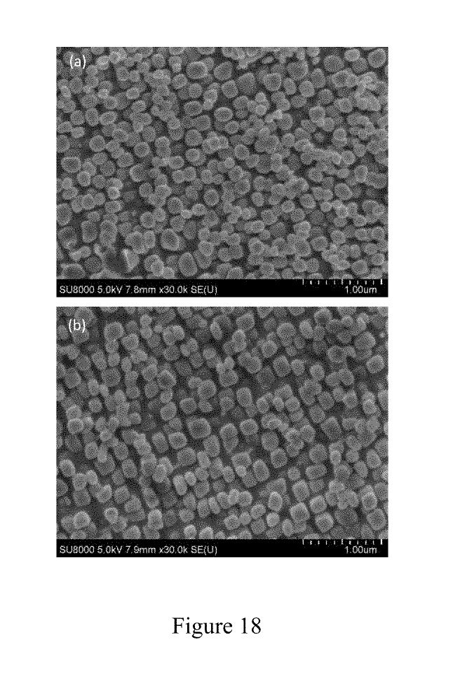

Aging heat treatment of both the WGB and the LBW materials results in the precipitation of similar gamma prime phase, as depicted in FIG. 18.

The differences in ductility and tensile strength observed between identical compositions prepared by WGB and LBW can be understood with respect to the microstructure developed by each process. Boride phases are known to be relatively brittle. The larger borides formed by the WGB process are concentrated in the interstices between the original M247 powder particles. These borides are thought to provide a ready crack propagation path, with the result that the properties are dominated by the brittle behavior of the borides. The composition of the boride phases formed from LBW, and hence their intrinsic properties, are similar to those formed by WGB. But the particles are smaller and more uniformly distributed. For LBW materials, it is believed that the properties are dominated by the gamma prime strengthened nickel matrix and so the properties are much closer to those of the conventional M247 superalloy.

The high ductility of the LBW materials and to a lesser extent the WGB materials at higher temperatures is not well understood. Similar behavior has been observed for weld deposition of other alloys containing similar boron additions. This ductility is likely one of the principal factors in the excellent weldability of the materials. There are no obvious microstructural features that seem likely to cause this behavior. Further investigation is planned to determine the mechanisms involved.

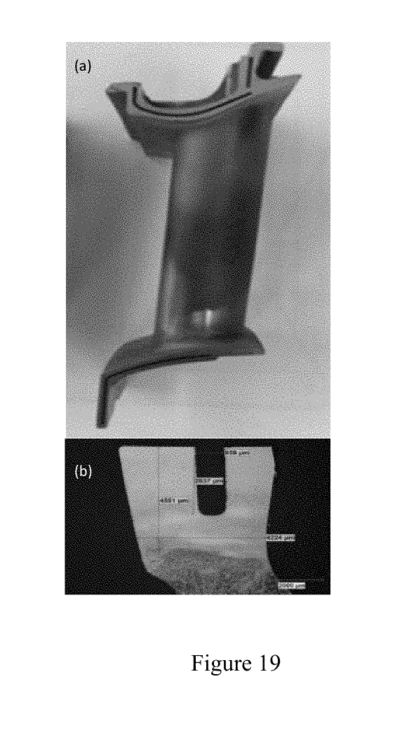

While the properties of LBW material are superior to the WGB materials, both processes have specific applications in repair of turbine engine components. LBW with ‘B’ powder blends is used for structural repairs of turbine engine components where optimum mechanical properties are important. Examples include tip repair of HPT and LPT turbine blades and trailing edge, flange and abutment faces restoration on NGV's as depicted in FIG. 19. The laser cladding process is also used for 3D AM parts and so these mixtures would also be suitable for manufacture of high temperature components.

As a furnace based process, the LPM™ WGB process does not produce residual stresses like LBW or other welding technologies. This is an advantage for applications involving heavy deposition of materials where those stresses would cause excessive distortion. Example include the repair of airfoils, throat restoration, and large damaged areas on the shrouds of NGV, as shown in FIG. 19.

Based on the study, the following conclusions can be drawn:

1). Mar M247 modified with 0.15-1.2 wt. % B and preferably 0.4 to 0.6 wt. % B demonstrated a unique combination of high UTS, ductility, crack resistance, weldability and thermal stability due to a formation of interconnected framework of high temperature dendrites with low boron content, interdendritic B based eutectic and precipitation of discrete cuboidal borides of VIB group elements.

2). Annealing and primary aging of LBW welds at temperatures ≥1200° C. and 1120° C. respectively resulted in further depletion of Ni—Cr γ solid solution with boron reducing boron content to a level of its solubility in Ni and formation of discrete refractory chromium and tungsten borides producing joints and materials for 3D AM with high strength and ductility.

3). Mechanical properties of ‘A’ wide gap brazed materials produced by braze infiltration of the sintered in the solid state Mar M247 filler powder particles followed by sintering in liquid phase were noticeably below of properties of materials produced by a laser beam cladding with the same powder blends at temperatures up to 926° C. due to formation of a composite-like structure comprised brazed based matrix with imbedded Mar M247 powder particles that controlled mechanical properties of WGB material.

4). Based on the current study and repair history, laser beam welding with powder blends and homogeneous Mar M247 modified with 0.4-0.6 wt. % B can be recommended for repairs of turbine engine components manufactured from Mar M247, Inconel 738, GTD 111, Rene 77, Rene 80, Rene 142, Mar M002, PWA1484, CMSX-4, and Rene N5 and other equiaxed, directionally solidified and single crystal materials and 3D additive manufacturing of NGV, seal segments, shrouds and other parts for turbine engine components.

Exemplary embodiments are further disclosed based on the examples below.

To demonstrate the capabilities of the invented method and composite welding powders for a repair of engine components multi pass cladding was made on Inconel 738, Mar M002, Inconel 625, Rene N5 and austenitic stainless steel 304 base materials.

Automatic laser beam cladding was made using a Liburdi LAWS 1000 laser welding system equipped with the 1 kW laser.

Automatic microplasma (MPW) welding was made using a Liburdi LAWS 4000 system.

Manual GTAW-MA welding was made using a Liburdi PulsWeld 100 power source and standard welding torch. Results of experiments are discussed below in Examples 1 through 9.

### Example 1

Three (3) passes automatic microplasma pulsed cladding was made at an ambient temperature using filler material comprised of 70% Mar M247 high temperature filler and 30% AWS BNi-9 brazing powders on the Inconel 738 substrate of 0.060-0.070 inch in width.
Following below parameters were used:
Traveling (welding) speed—2 ipm (inch per minute)
Powder feed rate—3 g/min

### Max Weld Current—21.8 A

### Min Weld Current—15.6 A

### Duty Cycle—60%

### Frequency—3 Hz

Shielding Gas—argon
Pilot arc gas—argon

Welded samples were subjected to a post weld heat treatment in vacuum with a pressure below of 10⁻⁴ torr at a temperature of 1120°±10° C. for two (2) hours. At this temperature the material of the clad welds was in a solid-liquid condition that allowed self healing of micro cracks in clad welds and the formation of eutectic alloy along the fusion line resulting in a healing of micro cracks.

No cracks were observed in clad welds and HAZ. Typical micrographs of samples are shown in FIGS. 1a and 1b.

### Example 2

Three (3) passes laser cladding was made at an ambient temperature using filler material comprised of 75% Inconel 738 high temperature filler and 25% AWS BNi-9 brazing powders on the Inconel 738 substrate of 0.080-0.090 inch in width at an ambient temperature.

To produce clad welds of 0.090-0.100 inch in width the laser welding head was oscillated perpendicular to the welding direction.

To minimize overheating of the substrate during the first pass and ensure good fusion between passes the laser beam power was incrementally increased from the first pass to the top (last) one.

Following below welding parameters were used:

Welding speed—3.8 ipm
Powder feed rate—6 g/min
Oscillation speed (across weld samples)—45 ipm
Oscillation distance—0.033 inch either side of the center line of the sample
Beam power: 325 W (first pass), 350 W (second pass), 400 W (third pass)
Carrier gas—argon
Shielding gas—argon

After welding samples were cut in two equal parts.

One part was subject to a metallographic evaluation in as welded condition. We observed self-healing of microcracks in the HAZ during laser welding by melted filler material that was sucked from the welding puddle by the capillary action into cracks is shown in FIG. 3 a.

The second part of the sample was subjected to a post weld heat treatment in vacuum with a pressure below of 10⁻⁴ torr at a temperature of 1200°±10° C. for two (2) hours. At this temperature the material of the clad welds was in a solid-liquid condition that allowed self healing of micro cracks in welds. We observed formation of the eutectic alloy along the fusion line that eliminated all evidences of original HAZ micro cracking as shown in FIG. 3 b.

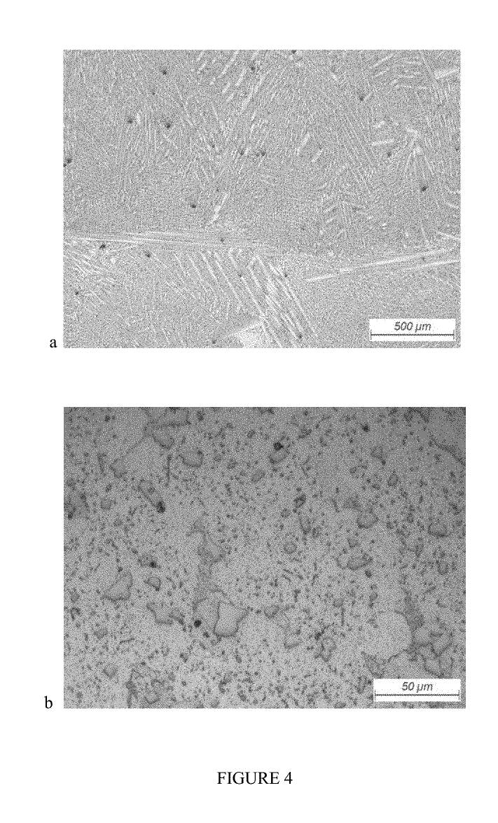

The post weld heat treatment resulted also in a decomposition of oversaturated solid solution, precipitation of boron-rich particles as shown in FIG. 4 and reduction of microhardness of clad welds to a level of the parent material as shown in the Table 1 below that confirmed the feasibility of using the invented methods for a repair structural engine components:

TABLE 1
Microhardness of clad welds

| | In “As Welded” | After Heat |
|---|---|---|
| Material | Condition, HV | Treatment, HV |
| Parent Material | 427 | 419 |
| HAZ | 425 | 418 |
| Diffusion Zone | N/A | 433 |
| Clad Weld Pass 1 | 554 | 445 |
| Clad Weld Pass 2 | 581 | 481 |
| Clad Weld Pass 3 | 573 | 407 |

### Example 3

Three (3) passes laser cladding was made at an ambient temperature using filler powder comprised of 73% Inconel 738 high temperature filler and 27% AWS BNi-9 brazing powders on the Mar 002 substrate of 0.080-0.090 inch in width.

To produce clad welds of 0.090-0.100 inch in width the laser head was oscillated perpendicular to the welding direction.

Following below welding parameters were used:

Welding speed—3.8 ipm
Powder feed rate—8 g/min
Oscillation speed (across weld samples)—45 ipm
Oscillation distance—0.033 inch either side of the center line of the sample
Beam power: 475 W for all three passes
Carrier gas—argon
Shielding gas—argon

Welded samples were subjected to a post weld heat treatment in vacuum with a pressure below of 10⁻⁴ torr at a temperature of 1200°±10° C. for two (2) hours. At this temperature the material of the clad welds was in a solid-liquid condition that allowed self healing of micro cracks in the welds. We observed the formation of the eutectoid alloy along the fusion line and healing micro cracks in the HAZ as it was confirmed by FPI and metallographic evaluation.

Inconel 738—AWS BNi-9 filler material combines acceptable oxidation resistance and high mechanical properties due to ability of excessive boron to diffuse into the parent material. Therefore, this material is most suitable for the repair of structural components, such as casings, nozzle guide vanes (NGV) and turbine blades of land based industrial engines.

### Example 4

Three (3) pass laser cladding was made at an ambient temperature using filler powder comprised of 75% Inconel 738 high temperature filler and 25% AMS 4782 silicon based brazing powders on the Inconel 738 substrate of 0.080-0.090 inch in width.

To produce clad welds of 0.100-0.120 inch in width the laser welding head was oscillated perpendicular to the welding direction.

Following below welding parameters were used:

Welding speed—3.8 ipm
Powder feed rate—8 g/min
Oscillation speed (across weld samples)—45 ipm
Oscillation distance—0.033 inch either side of the center line of the sample
Beam power: 475 W for all passes
Carrier gas—argon
Shielding gas—argon

Welded samples were subjected to a post weld heat treatment in vacuum with a pressure below of 10⁻⁴ torr at a temperature of 1120°±10° C. for two (2) hours. At this temperature the material of the clad welds was in solid-liquid condition producing healing of micro cracks.

FPI and metallographic evaluation confirmed that samples were free of cracks. A typical micrograph of a sample is shown in FIG. 5.

Silicon significantly increases oxidation resistances of clad welds in comparison with parent material and boron based brazing materials. Inconel 738—AMS4782 composition is most prominent for a relatively shallow tip restoration of aero turbine blades.

### Example 5

Evaluation of clad welds produced using 50% Mar M247 filler and 50% AMS4782 brazing powders was made for axial crack repair and tip restoration of turbine blades manufactured of standard polycrystalline and single crystal alloys.

Three (3) pass laser cladding was made on Inconel 738 substrate of 0.080-0.090 inch in width at an ambient temperature.

To produce a weld of 0.100-0.120 inch in width the laser welding head was oscillated across the sample.

Following below welding parameters were used:

Welding speed—3.8 ipm
Powder feed rate—6 g/min
Oscillation speed (across weld samples)—45 ipm
Oscillation distance—0.033 inch either side of the center line of the sample
Beam power: 475 W for all three passes
Carrier gas—argon
Shielding gas—argon

### Fiber Diameter—800 μm

Filler powder diameter—45-75 μm

Welded samples were subjected to a post weld heat treatment in vacuum with a pressure below of 10⁻⁴ torr at a temperature of 1220°±10° C. for two (2) hours.

Metallographic evaluation confirmed that samples have met relevant acceptance standards.

### Example 6

To perform evaluation of crack resistance of clad welds with minimum amount of brazing powder laser clad welding was made at an ambient temperature on Mar M 002 substrate using 95% Rene 142 high temperature welding powder and AWS BNi-9 brazing powder to simulate repair of directionally solidified and single crystal blades and NGV.

Width of samples varied from 0.080 to 0.100 inch.

To produce clad welds of 0.080-0.100 inch in width the laser welding head was oscillated perpendicular to a weld direction.

Following below welding parameters were used:

Welding speed—3.8 ipm
Powder feed rate—8 g/min
Oscillation speed (across weld samples)—45 ipm
Oscillation distance—0.040 inch either side of the center line of the sample
Beam power: 475 W for all three passes
Carrier gas—argon
Shielding gas—argon

Welded samples were subjected to a post weld stress relief in vacuum below of 10⁻⁴ torr at a temperature of 885°±10° C. for two (2) hours. At this temperature the material of the clad welds were in a solid condition.

Microstructure evaluation did not reveal any indications that exceeded relevant acceptable limits

### Example 7

To simulate extensive repair of casing and other structural components manufactured of Inconel 625 superalloy at an ambient temperature the multi pass laser cladding of 0.750-1.1 inch in height was made using the filler material comprised of 75% Inconel 738 and 25% AWS BNi-9 powders using following below parameters:

Welding speed—3.8 ipm
Powder feed rate—8 g/min
Oscillation speed (across weld samples)—45 ipm
Oscillation distance—0.040 inch either side of the center line of the sample
Beam power: 475 W for all three passes
Carrier gas—argon
Shielding gas—argon

To reduce the residual stresses and prevent cracking, after weld build up of 0.250-0.500 inch in height samples were subjected to a post weld heat treatment in vacuum with a pressure below of 10⁻⁴ torr at a temperature of 1200°±10° C. for two (2) hours. At this temperature the material of the clad welds was in a solid-liquid condition that allowed self healing of micro cracks in clad welds. We observed the formation of a diffusion layer and recrystallization of a parent material along the fusion line and stress relief

Post heat treatment the laser cladding process was continued using the same welding parameters until reaching the required weld build up followed by another heat treatment cycle at a temperature of 1200°±10° C. for two (2) hours.

After the second heat treatment cycle, the weld build up remained practically at the same geometry with minor reduction in thickness of less than 5%.

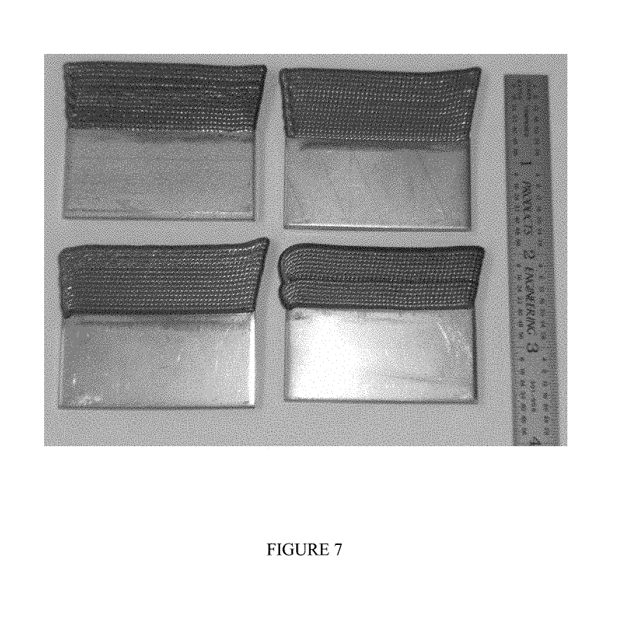

No cracks were found in clad welds and HAZ. Samples with clad welds are shown in FIG. 7.

### Example 8

Three (3) pass automatic microplasma pulsed cladding was made using filler material comprised of 70% Inconel 738 and 30% AWS BCo-1 brazing powders on Inconel 738 substrate of 0.060-0.070 inch in width at an ambient temperature.

Following below parameters were used:

Welding speed—2 ipm (inch per minute)
Powder feed rate—2.6 g/min

### Max Weld Current—22 A

### Min Weld Current—15 A

### Duty Cycle—60%

### Frequency—3 Hz

### Shielding Gas—95% Ar—5% H₂

Pilot arc gas—argon

Welded samples were subjected to a post weld heat treatment in vacuum with a pressure below of 10⁻⁴ torr at a temperature of 1220°±10° C. for two (2) hours. At this temperature the material of clad welds was in a solid-liquid condition that allowed self healing of micro cracks in clad welds. We observed formation of a diffusion layer and recrystallization of a parent material along the fusion line and healing of microcracks. No cracks were found in the clad welds and in the HAZ.

### Example 9

To evaluate mechanical properties of multi pass laser clad welds produced on the sacrificial base material, which was fully removed and discarded after welding, following below powders were used:

High temperature welding powder (referred to herein as LBHT for Liburdi Blend High Temperature) consisting of in wt. % the below chemical elements:

### Co 9-15%;

### Al 3-6.5%;

### C 0.1-0.2%;

Ti, Zr and Hf with a total content from 1 to 8.5%;
Ta and Nb with a total content from 0.5 to 8.5%;
W and Mo with a total content from 7 to 20%;
Cr and Re with a total content from 6.5 to 18.5%;
Fe and Mn with a total content from 0.1 to 1%;
Ni and impurities to balance.

Braze Compositions:

Composition 1 of the boron based brazing powder (referred to herein as Braze 1) comprised (in wt. %):

Ni-20% Co-20% Cr-3% Ta-3% B-0.1La

Composition 2 of the silicon based brazing powder powder (referred to herein as Braze 2) comprised (in wt. %):

Ni-19% Cr-10% Si

Composition 3 of boron and silicon containing brazing powder powder (referred to herein as Braze 3) comprised (in wt. %):

Co-22% Cr-21% Ni-14% W-2% B-2% Si—0.03% La

Content of the brazing material varied from 5 to 50% as shown in Table 2.

To produce weld buildup of 5×2×0.120 inch in size laser cladding was used.

PWHT of welds was made in a vacuum of 0.5·10⁻⁴ torr at a temperature of 1205°±10° C. followed by two stage aging heat treatment at a temperature of 1120°±10° C. for two (2) hours 845° C. for sixteen (16) hours and argon quench to compare mechanical properties of welds with Inconel 738 base material.

Tensile testing of welds was made at a temperature of 982° C. as per ASTM E21.

The accelerated cyclic oxidation test was made in air at a maximum temperature of 1100° C. followed by air cooling to an ambient temperature.

As followed from the Table 2 welds produced using boron based brazing powder with the Composition 1 demonstrated superior mechanical properties and exceptional ductility that exceeded mechanical properties of Inconel 738 and standard welding materials Inconel 625 and Haynes 230 that have being used for a repair of turbine blades at a temperature of 980° C. However, boron additives reduce oxidation resistance at a temperature of 1100° C. as shown in Table 3.

Mechanical properties of welds produced silicon based brazing powder with the Composition 2 had a superior oxidation resistance that exceeded the oxidation resistance of Rene 80 and Rene 142 welds and moderate mechanical properties that were not suitable for a repair of structural components and 3D AM.

However, welds produced using B and Si containing brazing powder with the Composition 3 have had mechanical properties that were between welds comprised of only B and Si. These materials were found suitable for a repair of structural components, NGV, tip repair of LPT blades and 3D AM.

TABLE 2
Mechanical Properties of Laser Clad Welds in Comparison
with Properties of Inconel 738 and some Standard
Superalloys at a Temperature of 982° C.

| | | |
|---|---|---|
| Material | UTS, KSI | Elongation, % |

Clad Welds

| | | |
|---|---|---|
| 9a) WP + 25% of Braze Composition 1 | 64.8 | 19.5 |
| 9b) WP + 15% of Braze Composition 1 | 60.8 | 16 |
| 9c) WP + 10% of Braze Composition 1 | 67.1 | 18.4 |
| 9d) WP + 5% of Braze Composition 1 | 63.3 | 12.4 |
| 9e) WP + 35% of Braze Composition 2 | 35.3 | 15.1 |
| 9f) WP + 50% of Braze Composition 3 | 44 | 18.8 |

Standard Superalloys

| | | |
|---|---|---|
| Inconel 738 | 49.4 | 15.5 |
| Haynes 230 | 29.4 | 24.8 |
| Inconel 625 | 24.1 | 45.9 |

TABLE 3
Cyclic Oxidation Resistance of Welds and Inconel 738

| | Materials | | | | | |
|---|---|---|---|---|---|---|
| | WP + 25% | WP + 35% | | IN738 | René 80 | René 142 |
| | of Braze | of Braze | WP + 50% of | (Base | (Base | (Base |
| | Comp. 1 | Comp. 2 | Braze Comp. 3 | Mater.) | Mater.) | Mater.) |
| Weight | −0.1338 | −0.0025 | −0.2249 | −0.0426 | −0.0936 | −0.0178 |
| Change, | | | | | | |
| g/cm³ | | | | | | |

TABLE 4
Composition of High Temperature Welding and Filler Powders and Braze Powders in wt. %

| High Temperature Welding and | | | | | | | | | | |
|---|---|---|---|---|---|---|---|---|---|---|
| Filler Powders | | | | | | | | | | |
| | | | | Liburdi | | | | | | |
| | | | | Blend - | Braze Compositions | | | | | |
| | MAR | Inconel | Rene | High | AWS | AMS | AWS | | | |
| | M247 | 738 | 142 | Temp | BNi-9 | 4782 | BCo-1 | Comp. 1 | Comp. 2 | Comp. 3 |
| Co | 10 | 8-9 | 12 | 9-15 | — | — | bal | 20 | — | Bal. |
| Cr | 8.25 | 15.7-16.3 | 6.8 | (with | 15 | 19 | 18-20 | 20 | 19 | 22 |
| | | | | Re) | | | | | | |
| | | | | 6.5-18.5 | | | | | | |
| Mo | 0.7 | 1.5-2.0 | 1.5 | Total | — | — | — | — | — | — |
| W | 10 | 2.4-2.8 | 4.9 | 7-20 | — | — | 3.5-4.5 | — | — | 14 |
| Al | 5.5 | (with | 6.1 | 3-6.5 | 0.05 | 0.05 | 0.05 | — | — | — |
| | | Ti) | | | | | | | | |
| | | 6.5-7.20 | | | | | | | | |
| Ta | 3.0 | 1.5-2.0 | 6.3 | (with | — | — | — | 3 | — | — |
| | | | | Nb) | | | | | | |
| | | | | 0.5-8.5 | | | | | | |
| Ti | 1.0 | 3.2-3.7 | — | Total 1-8.5 | 0.05 | 0.05 | 0.05 | — | — | — |
| Hf | — | — | — | | — | — | — | — | — | — |
| Zr | — | 0.05-0.15 | — | | 0.05 | 0.05 | 0.05 | — | — | — |
| Fe | 0.5 | 0.5 max | — | (with | 1.5 | — | 1.0% | — | — | — |
| | | | | Mn) | | | | | | |
| | | | | 0.1-1 | | | | | | |
| C | — | 0.15-0.20 | 0.12 | 0.1-0.2 | 0.06 | 0.10 | 0.35-0.45 | — | — | — |
| B | 0.015 | 0.005-0.015 | — | — | 4.0 | 0.03 | 0.7-0.9 | 3 | — | 2 |
| Si | — | 0.30 | — | — | — | 10 | 7.5-8.5 | — | 10 | 2 |
| | | max | | | | | | | | |
| Ni | 59 | Bal. | Bal. | Bal. | Bal. | Bal. | 16-18 | Bal. | Bal. | 21 |

TABLE 5
Summary of Compositions of Experimental Examples, in wt. %

| | High Temperature Powders | | | | Braze | | | | | | | |
|---|---|---|---|---|---|---|---|---|---|---|---|---|
| | MAR | | Rene | | AWS | AMS | AWS | | | | | |
| | M247 | IN738 | 142 | LBHT | BNi-9 | 4782 | BCo-1 | Braze 1 | Braze 2 | Braze 3 | | |
| | B | | | | | | | | | | Weld | |
| | 0.015 | 0.015 | 0.015 | — | 4 | 0.03 | 0.7-0.9 | 3 | — | 2 | Metal | |
| | Si | | | | | | | | | | | Bulk |
| | — | 0.3 | — | — | 0 | 10 | 8 | — | 10 | 2 | Bulk B | Si |
| Ex. 1 | 70 | — | — | — | 30 | — | — | — | — | — | 1.2 | — |
| Ex. 2 | — | 75 | — | — | 25 | — | — | — | — | — | 1.1 | 0.22 |
| Ex. 3 | — | 73 | — | — | 27 | — | — | — | — | — | 1.1 | 0.22 |
| Ex. 4 | — | 75 | — | — | — | 25 | — | — | — | — | 0.012 | 2.7 |
| Ex. 5 | 50 | — | — | — | — | 50 | — | — | — | — | 0.015 | 5 |
| Ex. 6 | — | — | 95 | — | 5 | — | — | — | — | — | 0.21 | 0 |
| Ex. 7 | — | 75 | — | — | 25 | — | — | — | — | — | 1.0 | 0.22 |
| Ex. 8 | — | 70 | — | — | — | — | 30 | — | — | — | 0.28 | 2.6 |
| Ex. 9a | — | — | — | 75 | — | — | — | 25 | — | — | 0.75 | — |
| Ex. 9b | — | — | — | 85 | — | — | — | 15 | — | — | 0.45 | — |
| Ex. 9c | — | — | — | 90 | — | — | — | 10 | — | — | 0.3 | — |
| Ex. 9d | — | — | — | 95 | — | — | — | 5 | — | — | 0.15 | — |
| Ex. 9e | — | — | — | 65% | — | — | — | — | 35% | — | 0% | 3.5% |
| Ex. 9f | — | — | — | 50% | — | — | — | — | — | 50% | 1% | 1% |

Therefore, as it was discussed above, boron based brazing powders preferably should be used for a weld repair and manufacturing of structural engine components that exercise high stresses during service and have protective aluminizing or platinum-aluminizing coatings.

Boron-Silicon based brazing powders preferably should be used for tip restoration of turbine blades where the high oxidation resistance and ductility of welds is much more critical than rupture properties.

1. A method of cladding and fusion welding of super-alloys, comprising the steps of:
a) application of a composite filler powder to a superalloy base material, the composite filler powder comprising 5-50% by weight brazing boron bearing powder and 50-95% by weight high temperature nickel based super-alloy welding powder comprising at least one of Cr, Mo, W and Re alloying elements, wherein a bulk content of boron in a weld bead after solidification is within a range of 0.15-1.2% by weight;
b) simultaneous heating of the base material and the composite filler powder by a welding source that is movable relative to the base material with a speed from 2 to 45 inch per minute and a heat input from 200 W to 500 W that is configured to fully melt the brazing powder and the high temperature welding powder and also a surface layer of the base material, which upon solidification forms a weld bead structure having an interconnected framework of high melting temperature columnar dendrites in an interconnected inter-dendritic boron bearing eutectic matrix, and
c) post weld heat treatment at a temperature exceeding a liquidus temperature of the brazing powder but below the solidus temperature of the high temperature welding powder, configured to at least partially re-melt the interconnected inter-dendritic eutectic based matrix self-healing solidification cracks in the weld bead or a liquation crack along a weld fusion line wherein the weld bead is supported by the interconnected framework of high melting temperature columnar dendrites.

2. The method of cladding and fusion welding of superalloys according to claim 1, wherein the brazing powder includes boron and silicon as melting point depressants, wherein the bulk content of boron in a weld bead after solidification is within a range of 0.15-0.9% by weight and silicon is within a range of 0.5-1.5% by weight.

3. The method of cladding and fusion welding of superalloys according to claim 1, wherein bulk content of boron in a weld bead after solidification is within a range of 0.4-0.6% by weight.

4. The method of cladding and fusion welding of superalloys according to claim 1, wherein the welding parameters are chosen such that the ratio of the welding pool length in inches to the welding speed in inches per minute is 0.002-0.02 during welding.

5. The method of cladding and fusion welding of superalloys according to claim 1, wherein the brazing powder contains 0.3 to 4 wt. % of B.

6. The method of cladding and fusion welding of superalloys according to claim 2, wherein the brazing powder contains from 1 to 10 wt. % of Si and from 0.3 to 4 wt. % of B.

7. The method of cladding and fusion welding of superalloys according to claim 1, wherein the high temperature welding powder is selected from among Inconel 713, Inconel 738, Rene 77, CMSX-4, CMSX-10, Rene N4, Rene 5, Rene 6, Rene 80, Rene 125, Rene 142, Mar M247, Mar M002.

8. The method of cladding and fusion welding of superalloys according to claim 1, wherein the solidus temperature of the high temperature welding powder is selected within the range 1350° C. and 1500° C.

9. The method of cladding and fusion welding of superalloys according to claim 1, wherein the solidus temperature of the high temperature welding powder is selected within the range 1370° C. and 1450° C.

10. The method of cladding and fusion welding of superalloys according to claim 1, wherein the liquidus temperature of the brazing powder is selected within the range 875° C. and 1250° C.

11. The method of cladding and fusion welding of superalloys according to claim 1, wherein the liquidus temperature of the brazing powder is selected within the range 925° C. and 1220° C.

12. The method of cladding and fusion welding of superalloys according to claim 1, wherein the fusion welding process is a multi-pass cladding.

13. The method of cladding and fusion welding of superalloys according to claim 2, wherein the brazing powder is selected from nickel or cobalt based alloy, and comprises from 0.4 to 4 wt. % boron and from 1 to 4 wt. % silicon.

14. The method of cladding and fusion welding of superalloys according to claim 1, wherein the high temperature nickel based superalloy welding powder comprises at least one of:
Cr with a total content from 6.0 to 12.0%;
Mo with a total content from 1.5 to 5%;
W with a total content from 0 to 8%; and
Re with a total content from 1.5 to 3.5%.

15. The method of cladding and fusion welding of superalloys according to claim 1, wherein the high temperature nickel based superalloy welding powder comprises at least one of:
W and Mo with a total content from 7 to 20%;
Cr and Re with a total content from 6.5 to 18.5%.

16. The method of cladding and fusion welding of super-alloys according to claim 1, wherein the high temperature welding powder consists of in wt. % the following chemical elements:
Co 9-15%;
Al 3-6.5%;
C 0.1-0.2%;
Ti, Zr and Hf with a total content from 1 to 8.5%;
Ta and Nb with a total content from 0.5 to 8.5%;
W and Mo with a total content from 7 to 20%;
Cr and Re with a total content from 6.5 to 18.5%;
Fe and Mn with a total content from 0.1 to 1%;
Ni and impurities to balance.

17. The method of cladding and fusion welding of superalloys according to claim 1, further including a post weld heat treatment, selected from the group consisting of:
a. heat treatment is made at a temperature below the solidus temperature of the brazing powder but above 500° C. such that at least a partial stress relief of the weld bead and the base material occurs, and
b. heat treatment is made locally by a heating of the weld bead by the welding heat source, and
c. heat treatment is made at an annealing temperature of the base material, and
d. heat treatment is made at an aging temperature of the base material.

18. The method of cladding and fusion welding of superalloys according to claim 1, wherein the post weld heat treatment comprises annealing followed by aging heat treatments.

19. The method of cladding and fusion welding of superalloys according to claim 1, wherein the application of the composite welding powder to the base material is made using at least two consecutive passes.

20. The method of cladding and fusion welding of superalloys according to claim 1, wherein the post weld heat treatment is made after the application of at least two weld passes.

21. The method of cladding and fusion welding of superalloys according to claim 1, wherein the high temperature welding powder is similar to the base material.

22. The method of cladding and fusion welding of super-alloys according to claim 1, wherein the high temperature welding powder is dissimilar with the base material.

23. The method of cladding and fusion welding of superalloys according to claim 1, wherein the welding heat source is selected from among laser beam, electron beam, electric arc, and plasma.

24. The method of cladding and fusion welding of superalloys according to claim 1, wherein the welding is carried out at an ambient temperature without preheating of the base material.

25. The method of cladding and fusion welding of superalloys according to claim 1, wherein the method of welding is applied to an article consisting of the base material, and further includes the step selected from among, joining articles together, cladding the article for dimensional restoration, manufacturing the article and repair of the article.

26. The method of cladding and fusion welding of superalloys according to claim 1, wherein the article is a turbine blade selected from among a polycrystalline material, a directionally solidified material, and a single crystal material.

27. The method of cladding and fusion welding of super-alloys according to claim 25, wherein the article is selected from among a turbine blade, nozzle guide vane, a structural turbine engine component, a turbine casing, and a compressor blade.
